(19) United States
(12) Patent Application Publication
(10) Pub. No.: US 2025/0134746 A1
(43) Pub. Date: May 1, 2025

(54) WEARABLE DEVICE WITH DISTANCE SENSOR AND CONTROL METHOD THEREOF

(71) Applicant: Samsung Electronics Co., Ltd., Suwon-si (KR)

(72) Inventors: Mijeong KIM, Suwon-si (KR); Kiwan LEE, Suwon-si (KR)

(21) Appl. No.: 18/910,439

(22) Filed: Oct. 9, 2024

Related U.S. Application Data
(63) Continuation of application No. PCT/KR2024/012116, filed on Aug. 14, 2024.

(30) Foreign Application Priority Data
Oct. 27, 2023 (KR) 10-2023-0145815
Dec. 6, 2023 (KR) 10-2023-0175638

(51) Int. Cl. A61H 3/00; B25J 9/00; G01S 17/08; G01S 17/88

(52) U.S. Cl. CPC A61H 3/00; B25J 9/0006; G01S 17/08; G01S 17/88; A61H 2201/5007; A61H 2201/5092

(57) ABSTRACT

A wearable device including a distance sensor and a control method of the wearable device are provided. The control method of the wearable device may include measuring a signal related to a first distance from the wearable device to a first ground point using the first distance sensor, measuring a second distance from the wearable device to a second ground point using the second distance sensor, determining a first measurement distance from the wearable device to the first ground point based on a signal measured by the first distance sensor, determining a second measurement distance from the wearable device to the second ground point based on a signal measured by the second distance sensor, estimating a terrain type of a ground on which a user is located, based on the determined first measurement distance and the determined second measurement distance, and controlling at least one driving module based on the estimated terrain type.

### CROSS-REFERENCE TO RELATED APPLICATIONS

This application is a continuation application of International Application No. PCT/KR2024/012116 designating the United States, filed on Aug. 14, 2024, in the Korean Intellectual Property Receiving Office and claiming priority to Korean Patent Application No. 10-2023-0145815, filed on Oct. 27, 2023, and Korean Patent Application No. 10-2023-0175638, filed on Dec. 6, 2023, in the Korean Intellectual Property Office, the disclosures of which are all hereby incorporated by reference herein in their entireties.

### BACKGROUND

### 1. Field

Certain example embodiments relate to a wearable device with a distance sensor and/or a control method of such a wearable device.

### 2. Description of Related Art

Typically, a walking assistance device may be equipment or a device for assisting a patient, e.g., who is not able to walk by themselves due to various diseases or accidents, to perform walking exercise for rehabilitation or any patient for other exercise, and/or equipment or a device used for exercise. As the number of aging individuals increases, a growing number of people experience inconvenience in walking or have difficulty walking normally due to malfunctioning joint issues, and there is increasing interest in walking assistance devices. A walking assistance device may be worn on a body of a user to assist the user with walking by providing the necessary muscular strength and to induce the user to walk in a normal walking pattern, and/or to help with exercise. The walking assistance device may perform a function to assist various leg exercises (e.g., one or more of power walking, jogging, stair climbing, lunge, stretching) of a user.

### SUMMARY

In an example embodiment, a wearable device may include at least one driving module (e.g., including a motor and/or circuitry) configured to generate torque, a torque transmission frame configured to transmit the generated torque to a leg of a user wearing the wearable device, a fastener connected, directly or indirectly, to the torque transmission frame and configured to fasten the wearable device to the leg of the user, a first distance sensor configured to measure a signal related to a first distance from the wearable device to a first ground point, a second distance sensor configured to measure a signal related to a second distance from the wearable device to a second ground point that is different from the first ground point, and at least one processor, comprising processing circuitry, individually and/or collectively configured to control an operation of the wearable device. The at least one processor may be individually and/or collectively configured to determine a first measurement distance from the wearable device to the first ground point based on a signal measured by the first distance sensor, determine a second measurement distance from the wearable device to the second ground point based on a signal measured by the second distance sensor. The at least one processor may be individually and/or collectively configured to estimate a terrain type of a ground on which the user is located, based on the determined first measurement distance and the determined second measurement distance, and control the at least one driving module based on the estimated terrain type.

In an example embodiment, a wearable device may include at least one driving module (e.g., including a motor and/or circuitry) configured to generate torque, a torque transmission frame configured to transmit the generated torque to a leg of a user wearing the wearable device, a fastener connected, directly or indirectly, to the torque transmission frame and configured to fasten the wearable device to the leg of the user, a first distance sensor configured to measure a signal related to a distance from the wearable device to a first ground point, and at least one processor, comprising processing circuitry, individually and/or collectively configured to control an operation of the wearable device. The at least one processor may be configured to determine a first measurement distance from the wearable device to the first ground point based on a signal measured by the first distance sensor, and/or determine whether to output wearing guide content to induce normal wearing of the wearable device based on the determined first measurement distance.

In an example embodiment, a control method of a wearable device may include measuring a signal related to a first distance from the wearable device to a first ground point using the first distance sensor, measuring a second distance from the wearable device to a second ground point that is different from the first ground point using the second distance sensor, determining a first measurement distance from the wearable device to the first ground point based on a signal measured by the first distance sensor, determining a second measurement distance from the wearable device to the second ground point based on a signal measured by the second distance sensor, estimating a terrain type of a ground on which a user is located, based on the determined first measurement distance and the determined second measurement distance, and controlling the at least one driving module based on the estimated terrain type.

In an example embodiment, a control method of a wearable device may include measuring a signal related to a first distance from the wearable device to a first ground point using the first distance sensor, determining a first measurement distance from the wearable device to the first ground point based on a signal measured by the first distance sensor, and determining whether to output wearing guide content to induce normal wearing of the wearable device based on the determined first measurement distance.

In an example embodiment, a non-transitory computer-readable storage medium may store instructions that, when executed by at least one processor, cause the at least one processor to perform the control method of the wearable device.

### BRIEF DESCRIPTION OF THE DRAWINGS

The above and other aspects, features, and advantages of certain example embodiments of the present disclosure will be more apparent from the following detailed description, taken in conjunction with the accompanying drawings, in which:

FIG. 1 is a diagram illustrating an overview of a wearable device worn on a body of a user according to an example embodiment;

FIG. 2 is a diagram illustrating an exercise assistance system according to an example embodiment;

FIG. 3 is a rear schematic view of a wearable device according to an example embodiment;

FIG. 4 is a left side view of a wearable device according to an example embodiment;

FIGS. 5A and 5B are diagrams illustrating components of a wearable device according to an example embodiment;

FIG. 6 is a diagram illustrating an interaction between a wearable device and an electronic device according to an example embodiment;

FIG. 7 is a diagram illustrating a configuration of an electronic device according to an example embodiment;

FIGS. 8A and 8B are diagrams illustrating an operation of a distance sensor of a wearable device according to an example embodiment;

FIG. 9 is a flowchart illustrating operations of a control method of a wearable device performing control based on terrain-type detection according to an example embodiment;

FIGS. 10A, 10B, and 10C are diagrams illustrating a wearable device detecting a terrain type using a distance sensor and performing control based on a detected terrain type according to an example embodiment;

FIG. 11 is a flowchart illustrating operations of a control method of a wearable device performing a wearing state detection function according to an example embodiment;

FIG. 12 is a diagram illustrating a wearable device performing a wearing state detection function using a distance sensor according to an example embodiment;

FIG. 13 is a flowchart illustrating operations of a control method of a wearable device performing a wearing state detection function according to an example embodiment;

FIG. 14 is a diagram illustrating a wearable device performing a wearing state detection function using a plurality of distance sensors according to an example embodiment; and

FIG. 15 is a diagram illustrating a wearable device performing a wearing state detection function using a distance sensor and an inertial sensor according to an example embodiment.

### DETAILED DESCRIPTION

The following detailed structural or functional description is provided as an example only and various alterations and modifications may be made to the embodiments. Accordingly, the embodiments are not to be construed as limited to the disclosure and should be understood to include all changes, equivalents, or replacements within the idea and the technical scope of the disclosure.

The singular forms “a,” “an,” and “the” are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more of other features, integers, steps, operations, elements, components, and/or groups thereof.

Unless otherwise defined, all terms, including technical and scientific terms, used herein have the same meaning as commonly understood by one of ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments will be described in detail with reference to the accompanying drawings. When describing the examples with reference to the accompanying drawings, like reference numerals refer to like elements and a repeated description related thereto will be omitted.

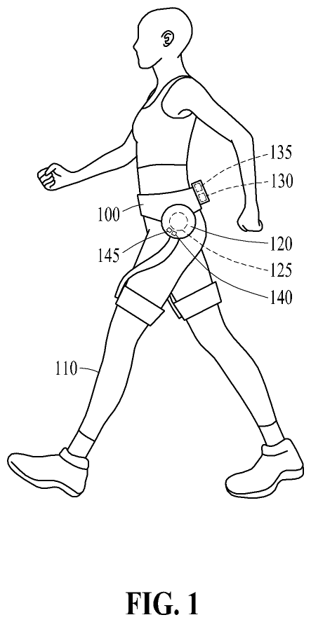

FIG. 1 is a diagram illustrating an overview of a wearable device worn on a user's body, according to an embodiment.

Referring to FIG. 1, in an embodiment, a wearable device 100 may be a device worn on a body of a user 110 to assist the user 110 in walking, exercising, and/or working. The wearable device 100 may be used to measure a physical ability (e.g., a walking ability, an exercise ability, or an exercise posture) of the user 110. In embodiments, the term “wearable device” may be replaced with “wearable robot,” “walking assistance device,” or “exercise assistance device”. The user 110 may be a person who walks, exercises, or performs a task while wearing the wearable device 100.

The wearable device 100 may be worn on the body (e.g., a lower body (legs, ankles, knees, etc.) or an upper body (a torso, a waist, arms, wrists, etc.) of the user 110 and may apply an external force, such as an assistance force and/or a resistance force, to a body motion of the user 110. The assistance force may be a force assisting the body motion of the user 110, which is applied in the same direction as a direction of the body motion of the user 110. The resistance force may be a force impeding the body motion of the user 110, which is applied in an opposite direction to the direction of the body motion of the user 110. The term “resistance force” may also be referred to as an “exercise load”.

In an embodiment, the wearable device 100 may operate in a walking assistance mode for assisting the user 110 in walking. In the walking assistance mode, the wearable device 100 may assist the walking of the user 110 by applying an assistance force generated through a driving module 120 of the wearable device 100 to the body of the user 110. The wearable device 100 may expand a walking ability of the user 110 by allowing the user 110 to walk independently or walk for a long time by providing a force needed for the walking of the user 110. The wearable device 100 may also improve the walking of a user having an abnormal walking habit or posture.

In an embodiment, the wearable device 100 may operate in an exercise assistance mode for enhancing the exercise effect of the user 110 or providing various exercise experiences to the user 110. The exercise assistance mode may include a resistance mode and an assistance mode. The resistance mode may represent a mode for hindering a body motion of the user 110 or providing resistance to a body motion of the user 110 by applying a resistance force generated by the driving module 120 to a body of the user 110. When the wearable device 100 is a hip-type wearable device that is worn on the waist (or pelvis) and legs (e.g., thighs) of the user 110, in the resistance mode, the wearable device 100 may provide an exercise load to a leg motion of the user 110 while being worn on the legs, thereby enhancing the exercise effect on the legs of the user 110. The assistance mode of the exercise assistance mode may be a mode for applying an assistance force for assisting a body motion of the user 110 to the body of the user 110. In the assistance mode, an assistance force in the same direction as a body motion may be provided to the user 110. For example, when a person with a disability or an elderly person wears the wearable device 100 to exercise, the wearable device 100 may provide an assistance force to assist a body motion. In the assistance mode, the wearable device 100 may provide a force in the same direction as a direction of a leg motion of the user 110 and the user 110 may exercise with a small force through the force provided from the wearable device 100. In an exercise program performed by using the wearable device 100, the resistance mode and the assistance mode may be combined and operated. For example, the wearable device 100 may provide a combination of an assistance force and a resistance force for each exercise session or time interval in such a manner of providing an assistance force in one exercise session and providing a resistance force in another exercise session. In the exercise assistance mode, various exercise programs may be operated depending on the exercise purpose or a physical ability of the user 110. The exercise program may be exercise content that the user 110 performs using the wearable device 100 and may include, for example, cardio, strength training, posture balancing, or any combination thereof. The type of the exercise program is not limited thereto and may be various. The resistance mode and the assistance mode may be alternately activated appropriately depending on an exercise program performed by the wearable device 100 and a target exercise speed that is suitable to an appropriate physical condition (e.g., a heart rate) of the user 110 may be guided to the user during the exercise of the user 110.

In an embodiment, the wearable device 100 may operate in a physical ability measurement mode for measuring a physical ability of the user 110. The wearable device 100 may measure motion information of the user 110 using a sensor (e.g., an angle sensor 125 and an inertia measurement unit (IMU) 135) provided in the wearable device 100 during the walking and/or exercise of the user 110 and may assess the physical ability of the user 110 based on the measured motion information. For example, a walking index (e.g., the number of walking steps, a total walking distance, and a stride length) or an exercise ability indicator (e.g., muscular strength, endurance, balance, or exercise motion) of the user 110 may be estimated through the motion information of the user 110 measured by the wearable device 100.

In some embodiments, the description is provided based on an example in which the wearable device 100 is a hip-type wearable device as shown in FIG. 1. However, the embodiments are not limited thereto. As described above, the wearable device 100 may be worn on other body parts (e.g., upper arms, lower arms, hands, calves, or feet) other than the waist or legs (specifically, thighs). The shape and configuration of the wearable device 100 may vary depending on the body part on which the wearable device 100 is worn.

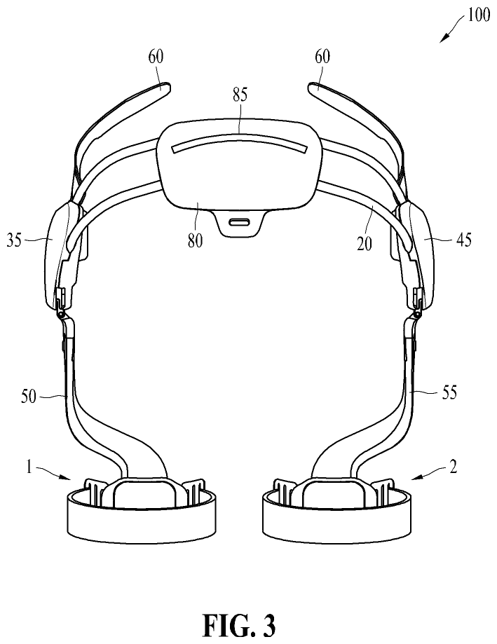

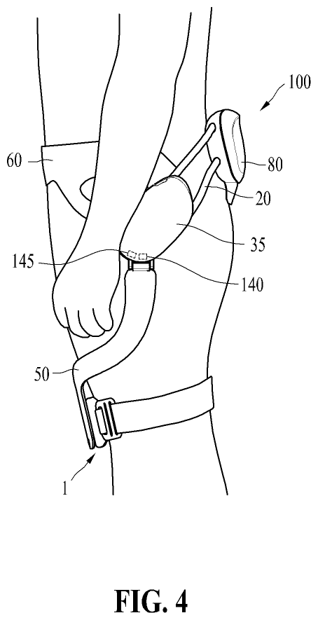

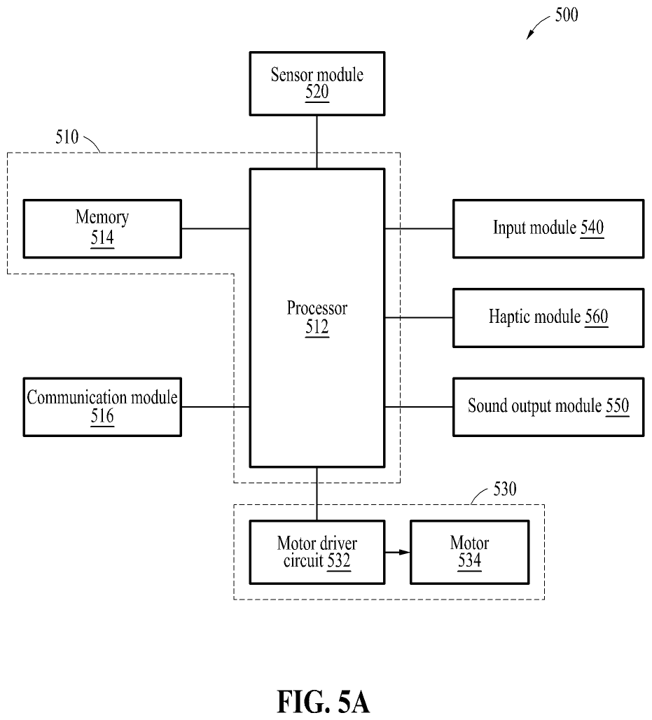

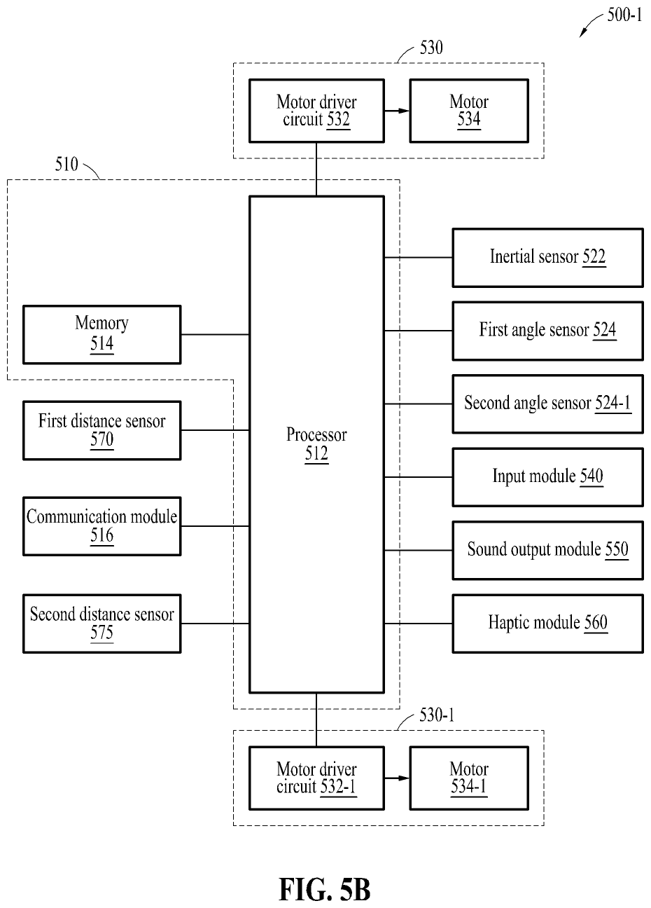

The wearable device 100 may include a support frame (e.g., a waist support frame 20 of FIGS. 3 and 4) for supporting the body of the user 110 when the wearable device 100 is worn on the body of the user 110, a driving module 120 (e.g., a first driving module 35 and a second driving module 45 of FIG. 3) configured to generate torque applied to legs of the user 110, a torque transmission frame (e.g., a first torque transmission frame 55 and a second torque transmission frame 50 of FIG. 3) configured to transmit torque generated by the driving module 120 to legs of the user 110, a sensor module (e.g., a sensor module 520 of FIG. 5A) including at least one sensor for obtaining sensor data including motion information about a body motion (e.g., a leg motion or an upper body motion) of the user 110, and a control module 130 (e.g., a control module 510 of FIGS. 5A and 5B, comprising circuitry) configured to control an operation of the wearable device 100.

In an embodiment, the wearable device 100 may include the angle sensor 125 and the IMU 135. The angle sensor 125 may measure a rotation angle of the torque transmission frame of the wearable device 100 corresponding to a hip joint angle of the user 110. The angle sensor 125 may include, for example, an encoder and/or a hall sensor. In an embodiment, the angle sensor 125 may be disposed adjacent to a position where a motor included in the driving module 120 is connected, directly or indirectly, to the torque transmission frame. The IMU 135 may include an acceleration sensor and/or an angular velocity sensor, and may measure a change in acceleration and/or angular velocity according to a motion of the user 110. For example, the IMU 135 may measure a motion value of a waist support frame (e.g., the waist support frame 20 of FIG. 3) or a base body (e.g., a base body 80 of FIG. 3) of the wearable device 100. The motion value of the waist support frame or the base body measured by the IMU 135 may correspond to a waist motion value (or an upper body motion value) of the user 110.

In an embodiment, the control module 130 and the IMU 135 may be disposed in the base body (e.g., the base body 80 of FIG. 3) of the wearable device 100. The base body may be on the waist of the user 110 when the user 110 wears the wearable device 100. The base body may be formed on or attached to the outside of the waist support frame of the wearable device 100. The base body may support the lumbar of the user 110.

In an embodiment, the wearable device 100 may provide haptic feedback to the user through a haptic module (e.g., a haptic module 560 of FIGS. 5A and 5B). The haptic module may include at least one haptic actuator configured to provide haptic feedback. The haptic feedback may be rapidly perceived by the user 110 without a separate confirmation procedure by the user 110 and may have an advantage over visual feedback and sound feedback because it is less limited by other factors, such as ambient noise.

For the user 110 to use the wearable device 100, the user 110 may need to wear the wearable device 100 and fasten the wearable device 100 to their body. The user 110 may wear the wearable device 100 to fit their body through a fastener including a belt and/or a band of the wearable device 100. For example, when the user 110 wears the wearable device 100, the user may fasten a waist fastener (e.g., a waist fastener 60 of FIGS. 3 and 4) of the wearable device 100 to fit the waist size of the user and may fasten both thigh fasteners (e.g., thigh fasters 1 and 2 of FIGS. 3 and 4) to fit the sizes of both thighs. When the wearable device 100 worn on the body of the user 110 fits the body size of the user 110, an external force (or torque) generated by the wearable device 100 may be accurately and efficiently transmitted to the body of the user 110, and a safe operation of the wearable device 100 may be ensured.

According to various example embodiments, the wearable device 100 may perform a wearing state detection function to detect whether the wearable device 100 is normally (or properly) worn on the body of the user 110. The wearable device 100 may perform the wearing state detection function not only before the wearable device 100 performs a substantial application operation (e.g., performing an exercise program) but also while performing an application operation.

In an embodiment, the control module 130 and the IMU 135 may be disposed in the base body (e.g., the base body 80 of FIG. 3) of the wearable device 100. The base body may be on the waist of the user 110 when the user 110 wears the wearable device 100. The base body may be formed on or attached to the outside of the waist support frame of the wearable device 100.

In an embodiment, the wearable device 100 may include one or more distance sensors 140 and 145. For example, the one or more distance sensors 140 and 145 may be disposed in a housing of the driving module 120 and may measure a signal related to a distance between the wearable device 100 and the ground. The distance between the distance sensor and the ground may be regarded as a distance between the wearable device 100 and the ground. The distance between the wearable device 100 and the ground may also be referred to as a depth between the wearable device 100 and the ground. The one or more distance sensors 140 and 145 may be disposed in the housings of the driving modules disposed on the left and right sides of the wearable device 100, respectively, or may be disposed on the housing of one of the driving modules. The number of distance sensors included in the wearable device 100 is not limited. For example, the wearable device 100 may have only one distance sensor 140 or two or more distance sensors. The one or more distance sensors 140 and 145 may be a time of flight (ToF) sensor that calculates a distance based on a time taken for light (e.g., infrared light, ultrasonic waves, and laser) radiated toward a measurement target to be reflected and returned. The one or more distance sensors 140 and 145 may be a one-dimensional (1D) ToF sensor that measures a signal related to a distance from the sensor to a measurement point or 3D ToF sensor that measures distances to various measurement points. The one or more distance sensors 140 and 145 may be an ultrasonic sensor, an infrared sensor, a Lidar sensor, a radar sensor, or a camera sensor, and the example is not limited thereto. The one or more distance sensors 140 and 145 may include a light transmitter configured to output light to a measurement target in a determined direction and a light receiver configured to sense light reflected by the measurement target. A distance to the measurement target may be calculated based on the time (or a phase difference between output light and reflected light) taken until the light output by the light transmitter is sensed by the light receiver and the moving velocity of the light.

In an embodiment, the wearable device 100 may detect a terrain type using the one or more distance sensors 140 and 145 and may perform a control function based on the detected terrain type. The user 110 may perform exercise, such as walking outdoors while wearing the wearable device 100, and in this situation, the wearable device 100 may recognize a terrain type in an exercise direction in a moving process of the user 110 in advance and may control an operation of the wearable device 100 based on the recognized terrain type. The wearable device 100 may determine a first measurement distance from the wearable device 100 to the ground in a first direction (e.g., a downward direction perpendicular to the ground) using the first distance sensor 140 and may determine a second measurement distance from the wearable device 100 to the ground in a second direction (e.g., a forward and downward direction) that is different from the first distance using the second distance sensor 145. The wearable device 100 may distinguish the type of terrain (e.g., flat ground, uphill terrain, downhill terrain) on which the user stands, walks, or exercises based on the first measurement distance and the second measurement distance while the user 110 wears the wearable device 100. The first measurement distance and/or the second measurement distance may be different from each other based on whether the user 110 is on flat ground, uphill terrain, or downhill terrain. In an embodiment, when the user 110 is on a reference terrain (e.g., flat ground), the first measurement distance measured using the first distance sensor 140 and the second measurement distance measured using the second distance sensor 145 may be set to a first reference distance and a second reference distance, respectively. When the determination of the terrain type is required, the wearable device 100 may measure the first measurement distance through the first distance sensor 140 and may measure the second measurement distance through the second distance sensor 145. In an embodiment, the wearable device 100 may distinguish the terrain type of the ground on which the user 110 is located at a measurement time point by comparing a ground length determined based on the first reference distance and the second reference distance with a ground length determined based on the first measurement distance and the second measurement distance. For example, when it is assumed that a first distance (the first measurement distance or the first reference distance) measured by using the first distance sensor 140 and a second distance (the second measurement distance or the second reference distance) measured by using the second distance sensor 145 are two sides of a triangle and an angle formed by light output by the first distance sensor 140 and light output by the second distance sensor 145 is an angle between the two sides, the ground length may correspond to the length of a remaining side of the triangle. The ground length determined in the uphill terrain may be less than the ground length determined on the flat ground, and the ground length determined in the downhill terrain may be greater than the ground length determined on the flat ground, and based on the characteristics described above, the wearable device 100 may estimate the terrain type of ground on which the user 110 is located. The wearable device 100 may control an operation of the wearable device 100 based on the estimated terrain type of the ground. The wearable device 100 may maintain a current operation state (e.g., an operation mode, a torque pattern) of the wearable device 100 based on the estimated terrain type of the ground, may decrease the magnitude of generated torque, or may stop generating the torque. Alternatively, the wearable device 100 may change (e.g., change from the assistance mode for generating an assistance force to a resistance mode for generating a resistance force, change from the resistance mode to the assistance mode, or change to a non-torque mode that does not generate torque from the resistance mode or the assistance mode) the operation mode of the wearable device 100 based on the estimated terrain type of the ground. For example, when an uphill terrain (e.g., an uphill road or uphill stairs) is detected, the wearable device 100 may control the driving module 120 to generate an assistance force to assist the user 110 to easily walk on the uphill terrain. When a downhill terrain (e.g., a downhill road or downhill stairs) is detected, the wearable device 100 may control the driving module 120 not to generate the resistance force or torque to assist the user 110 to safely move on the downhill terrain. As described above, the wearable device 100 may recognize the terrain in a front direction of the user 110 using the one or more distance sensors 140 and 145 and may provide a differentiated experience to the user through the control of the operation mode and/or torque according to the recognized terrain.

In an embodiment, the wearable device 100 may perform a wearing state detection function using the one or more distance sensors 140 and 145. The wearable device 100 may determine whether the wearable device 100 is worn at an appropriate wearing height (or a wearing position) based on the distance from the wearable device 100 to the ground measured by using the one or more distance sensors 140 and 145. When it is determined that the wearable device 100 is not worn at the appropriate wearing height (e.g., worn in a position that is higher or lower than the appropriate height), the wearable device 100 may output content (e.g., a voice guide, haptic feedback, and visual feedback) to the user 110 to induce normal wearing of the wearable device 100. The distance from the wearable device 100 to the ground measured by the one or more distance sensors 140 and 145 may be related to the height from the ground to the wearable device 100. As the height from the ground to the wearable device 100 increases, the distance between the wearable device 100 and the ground may increase. The wearable device 100 may determine whether the wearable device 100 is worn at the appropriate wearing height by comparing the measured distance with a reference distance range. The reference distance range may be a distance range (e.g., a distance range with the reference distance as a median) determined based on the reference distance, and the reference distance may correspond to a distance from the wearable device 100 to the ground measured by using the one or more distance sensors 140 and 145 in an assumed situation in which the user 110 wears the wearable device 100 at an appropriate wearing height. For example, the reference distance may correspond to a distance between the wearable device 100 and the ground measured during a personalization process of the wearable device 100 for the user 110 or a distance between the wearable device 100 and the ground measured when the user 110 requests to set a reference distance through a user input. For example, the personalization process of the wearable device 100 may be a test process conducted when the user 110 wears the wearable device 100 for the first time and through the test, a wearing state, which is the reference of the wearable device 100 and/or a physical condition and an exercise ability of the user 110. Each time the user 110 wears the wearable device 100, a wearing position of the wearable device 100 may vary. The wearable device 100 may determine whether the user 110 wears the wearable device 100 in an appropriate wearing position using the one or more distance sensors 140 and 145, and if it is determined that the user 110 does not wear the wearable device 100 in the appropriate wearing position, the wearable device 100 may guide the user 110 to wear the wearable device 100 in the appropriate wearing position through a voice guide, etc. Depending on the wearing position of the wearable device 100, not only the sense of adhesion and pressure that the user 110 feels but also a value of torque output by the driving module 120 and transmitted to the user 110 may vary, and due to this, a problem that exercise experience felt by the user 110 varies each time may occur. The wearable device 100 may solve the problem described above by automatically measuring the wearing position of the wearable device 100 worn by the user 110 and guiding the user 110 to ensure that the wearing position of the wearable device 100 is in the appropriate wearing position.

In an embodiment, the wearable device 100 may perform the wearing state detection function using the IMU 135. The IMU 135 may measure a degree of tilting of the wearable device 100, and the wearable device 100 may determine whether the wearable device 100 is worn symmetrically in the horizontal direction (or horizontally) by analyzing a signal measured by the IMU 135. When it is determined that the wearable device 100 is asymmetrically worn in the horizontal direction on the body of the user 110, the wearable device 100 may output content (e.g., a voice guide, haptic feedback, visual feedback) to the user 110 to induce normal wearing of the wearable device 100. The wearable device 100 may automatically measure the degree of horizontal tilting of the wearable device 100 in a state in which the user 110 wears the wearable device 100 and may guide the user 110 to ensure that the wearable device 100 is worn horizontally in balance. Through this, the wearable device 100 may improve the wearing experience of the wearable device 100 for the user 110 and may decrease the possibility of malfunction and/or user dissatisfaction due to incorrect wearing of the wearable device 100.

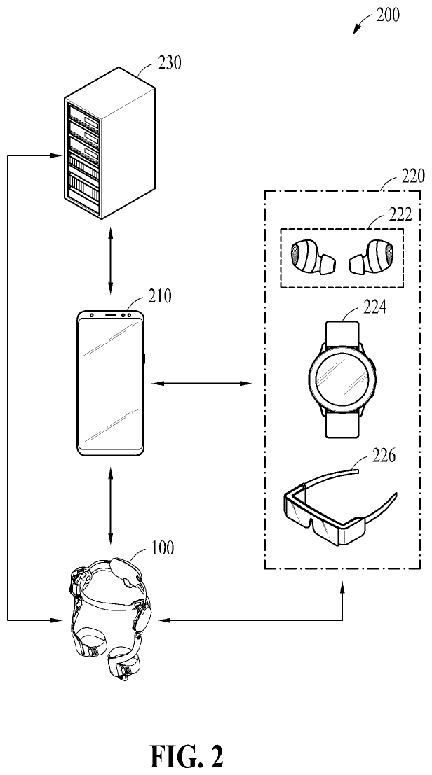

FIG. 2 is a diagram illustrating an exercise assistance system according to an embodiment.

Referring to FIG. 2, an exercise assistance system 200 may include the wearable device 100, an electronic device (or a user terminal) 210, another wearable device 220, and a server 230. In the exercise assistance system 200, at least one of the devices (e.g., the electronic device 210, the another wearable device 220, and the server 230) other than the wearable device 100 may be omitted, or at least one device (e.g., a dedicated controller for the wearable device 100) may be added thereto.

In an embodiment, the wearable device 100 worn on a body of a user may assist the motion of the user in a walking assistance mode. For example, the wearable device 100 may be worn on the legs of the user to help the user in walking by generating an assistance force for assisting a leg motion of the user.

In an embodiment, the wearable device 100 may generate and apply a resistance force for hindering a body motion of the user and/or an assistance force for assisting a body motion of the user to the body of the user to enhance an effect of the user's exercise in the exercise assistance mode. In the exercise assistance mode, the user may select an exercise program (e.g., cardio such as power walking and outdoor walking, strength training such as squats, split lunges, dumbbell squats, and lunge and knee ups, a stretching exercise, a posture balancing exercise, or any combination thereof) that the user desires to conduct using the wearable device 100 through the electronic device 210 and/or exercise intensity applied to the exercise program. The wearable device 100 may control a driving module (e.g., the driving module 120 of FIG. 1) of the wearable device 100 based on the exercise program and/or the exercise intensity selected by the user. The wearable device 100 may adjust the strength of the resistance force and/or the assistance force generated by the driving module, based on the exercise intensity selected by the user. The wearable device 100 may control the driving module to generate a resistance force corresponding to the exercise intensity selected by the user. As the exercise intensity increases, the strength of the resistance force applied to the user may increase.

The wearable device 100 may transmit sensor data measured by a sensor (e.g., the angle sensor, the inertial sensor, and the distance sensor) to the electronic device 210 and may receive a control signal to control an operation of the wearable device 100 from the electronic device 210. The wearable device 100 may adjust an operation of the wearable device 100 in response to the control signal received from the electronic device 210.

The electronic device 210 may communicate with the wearable device 100 through wireless communication, may remotely control the wearable device 100, or may provide state information about a state (e.g., a booting state, a charging state, an operation state of an exercise program, and an error state) of the wearable device 100 to the user. The electronic device 210 may recommend an exercise program using the wearable device 100 to the user and may analyze an exercise performed by the user. The electronic device 210 may receive, from the wearable device 100, sensor data obtained by the sensor of the wearable device 100 and may estimate a current exercise state, an exercise result, an exercise posture, and/or a physical ability of the user based on the received sensor data. The electronic device 210 may provide the user with the estimated exercise state, the exercise result, the exercise posture, and/or the physical ability of the user through a graphical user interface (GUI). In an embodiment, the electronic device 210 may receive, from the wearable device 100, sensor data measured by the distance sensor of the wearable device 100 and may perform a terrain-type detection function, the control function based on the detected terrain type, and/or the wearing state detection function of the wearable device 100 described with reference to FIG. 1, based on the received sensor data.

In an embodiment, the user may execute a program (e.g., an application) in the electronic device 210 to control the wearable device 100 and may adjust an operation or a setting value (e.g., a torque magnitude output by a motor of a driving module, a volume of audio output by a sound output module, and brightness of a lighting unit) of the wearable device 100 through the program. The program executed by the electronic device 210 may provide a GUI for an interaction with the user. The electronic device 210 may be a device in various forms. For example, the electronic device 210 may include a portable communication device (e.g., a smartphone), a computer device, a portable multimedia device, or a home appliance (e.g., a television, an audio device, or a projector device), but examples are not limited to the foregoing devices.

In an embodiment, the electronic device 210 may be connected to the server 230 by using short-range wireless communication or cellular communication. The server 230 may receive user profile information of the user who uses the wearable device 100 from the electronic device 210 and may store and manage the received user profile information. The user profile information may include, for example, information about at least one of a name, an age, a gender, a height, a weight, medical history, or a body mass index (BMI). The server 230 may receive exercise history information about an exercise performed by the user from the electronic device 210 and may store and manage the received exercise history information. The server 230 may provide the electronic device 210 with various exercise programs or physical ability measurement programs to be provided to the user. In an embodiment, the server 230 may be connected to the wearable device 100. The server 230 may receive, from the wearable device 100, the sensor data measured by the wearable device 100 and may transmit, to the wearable device 100, a control signal for controlling an operation of the wearable device 100 and/or data related to the exercise program. In an embodiment, the server 230 may be a cloud server.

According to an embodiment, the wearable device 100 and/or the electronic device 210 may be connected to the other wearable device 220. Exercise result information, physical ability information, and/or exercise posture assessment information of the user determined by the electronic device 210 may be transmitted to the other wearable device 220 and may be provided to the user through the other wearable device 220. The state information of the wearable device 100 may be transmitted to the other wearable device 220 and may be provided to the user through the other wearable device 220. In an embodiment, the wearable device 100, the electronic device 210, and the other wearable device 220 may be connected to each other via wireless communication (e.g., Bluetooth communication or wireless fidelity (Wi-Fi) communication). The other wearable device 220 may be, for example, wireless earphones 222, a smartwatch (or a watch-type wearable device) 224, or smartglasses (a wearable device in the type of glasses or goggles) 226, but is not limited to the devices described above.

Each embodiment herein may be used in combination with any other embodiment(s) described herein.

In an embodiment, the wireless earphones 222 may be wirelessly connected to the electronic device 210 and/or the wearable device 100 and may output guiding voice, music, and/or a sound effect related to the exercise program. The wireless earphones 222 may provide information related to the exercise program (e.g., introduction to the exercise program or a remaining exercise time) to the user through the guiding voice or may ask the user to select. The wireless earphones 222 may include a microphone, and the microphone may receive a voice input from the user. The voice input received through the microphone may be transmitted to the electronic device 210, and voice recognition for the voice input may be performed by the electronic device 210.

In an embodiment, the smartwatch 224 may include a biometric sensor (e.g., a heart rate sensor and an electromyograph sensor) configured to measure a biosignal including heart rate information of the user and may transmit the biosignal measured by the biometric sensor to the electronic device 210 and/or the wearable device 100. For example, the electronic device 210 may estimate the heart rate information (e.g., a current heart rate, a maximum heart rate, and an average heart rate) and/or electromyography information of the user based on the biosignal received from the smartwatch 224, and may provide the user with the estimated heart rate information and/or the electromyography information. The heart rate information and/or the electromyography information may be used for the determination of the haptic intensity of the haptic feedback provided through the wearable device 100. “Based on” as used herein covers based at least on.

In an embodiment, the smartwatch 224 may include an inertial sensor configured to measure motion information of the user and/or a position sensor configured to measure position information of the user and may transmit the motion information and/or position information of the user to the electronic device 210 and/or the wearable device 100. The smartwatch 224 may include a communication module (e.g., a short-range communication module) for communicating with another device (e.g., the electronic device 210 and the wearable device 100). In an embodiment, the smartwatch 224 may provide an interface related to an exercise program through a display. The interface related to the exercise program may be implemented by a separate application installed in the smartwatch 224. The user may also control the wearable device 100 through the smartwatch 224.

In an embodiment, the smartglasses 226 may provide information to the user through a display in the form of glasses. For example, the smartglasses 226 may output information about, for example, a current exercise speed, a target exercise speed, a currently achieved exercise amount, an exercise time, and biometric information through a display in the exercise mode. In addition, the smartglasses 226 may output a screen to guide the user on an exercise path.

FIG. 3 is a rear schematic diagram of a wearable device according to an embodiment. FIG. 4 is a left side view of a wearable device according to an embodiment.

Referring to FIGS. 3 and 4, the wearable device 100 in an embodiment may include a base body 80, a waist support frame 20, driving modules 35 and 45, torque transmission frames 50 and 55, thigh fasteners 1 and 2, and a waist fastener 60. The base body 80 may include a lighting unit 85. In an embodiment, at least one (e.g., the lighting unit 85) of the components described above may be omitted from the wearable device 100 or one or more other components may be added to the wearable device 100.

The base body 80 may be on the waist of a user when the user wears the wearable device 100. The base body 80 may be worn on the waist of the user to provide cushioning to the waist of the user and may support the waist of the user. The base body 80 may be hung on the hip part (an area of the hips) to prevent or reduce a chance of the wearable device 100 from being downwardly separated due to gravity while the user wears the wearable device 100. The base body 80 may distribute a portion of the weight of the wearable device 100 to the waist of the user while the user wears the wearable device 100. The base body 80 may be connected to the waist support frame 20. Waist support frame connecting elements (not shown) to be connected to the waist support frame 20 may be provided at both ends of the base body 80.

In an embodiment, the lighting unit 85 may be provided on an outer surface of the base body 80. The lighting unit 85 may include a light source (e.g., a light-emitting diode (LED)). The lighting unit 85 may emit light in response to a control of a processor (not shown) (e.g., a processor 512 of FIGS. 5A and 5B) of the wearable device 100. In some embodiments, the lighting unit 85 may be controlled to provide (or output) visual feedback corresponding to the state of the wearable device 100 through the lighting unit 85.

In an embodiment, a display (not shown) may be provided on the outer surface of the base body 80. The display may provide various pieces of visual information (e.g., state information of the wearable device 100) related to the wearable device 100 and a screen for the GUI.

The waist support frame 20 may support a body part (e.g., the waist) of the user when the wearable device 100 is worn on the body of the user. The waist support frame 20 may extend from both ends of the base body 80. The waist of the user may be accommodated inside the waist support frame 20. The waist support frame 20 may include at least one rigid body beam. Each beam may be in a curved shape having a preset curvature to enclose the waist of the user. The waist fastener 60 may be connected to the end of the waist support frame 20. The driving modules 35 and 45 may be directly or indirectly connected to the waist support frame 20.

In an embodiment, a processor, a memory (e.g., a memory 514 of FIGS. 5A and 5B), an inertia sensor (e.g., the IMU 135 of FIG. 1 and an inertial sensor 522 of FIG. 5B), a communication module (e.g., a communication module 516 of FIGS. 5A and 5B), a sound output module (e.g., a sound output module 550 of FIGS. 5A and 5B), and a battery (not shown) may be disposed in the base body 80. The base body 80 may protect the components disposed therein. The processor may generate a control signal for controlling an operation of the wearable device 100. The processor may control a motor (or an actuator) of the driving module 35 or 45 configured to generate torque based on electrical energy stored in the battery. The processor and the memory may be included in the control module (e.g., the control module of FIGS. 5A and 5B). The control module may further include a power supply circuit to provide power from the battery to each component of the wearable device 100.

In an embodiment, the wearable device 100 may include a sensor module (not shown) (e.g., the sensor module 520 of FIG. 5A) including at least one sensor. For example, the sensor module may obtain sensor data, which may include motion information of the user and/or motion information of a component of the wearable device 100, and/or sensor data, which may include distance information about a surrounding area (e.g., the ground) of the wearable device 100, through the sensor. The sensor module may include an inertial sensor (e.g., the IMU 135 of FIG. 1 and the inertial sensor 522 of FIG. 5B) configured to measure a motion value of the upper body of the user or a motion value of the waist support frame 20, an angle sensor (e.g., the angle sensor 125 of FIG. 1, a first angle sensor 524 and a second angle sensor 524-1 of FIG. 5B) configured to measure a hip joint angle value of the user or a motion value of the torque transmission frame 50 or 55, and the one or more distance sensors 140 and 145 (e.g., a first distance sensor 570 and a second distance sensor 575 of FIG. 5B) configured to measure a distance from the wearable device 100 to the ground, but the example is not limited thereto. For example, the sensor module may further include at least one of a position sensor, a torque sensor, a pressure sensor, a temperature sensor, a biosignal sensor, a distance sensor, or a proximity sensor.

The waist fastener 60 may be directly or indirectly connected to the waist support frame 20 and may fasten the waist support frame 20 to the waist of the user. The waist fastener 60 may include, for example, a pair of belts.

The driving module 35 or 45 may generate an external force (or torque) applied to the body of the user based on the control signal generated by the processor. For example, the driving module 35 or 45 may generate an assistance force or a resistance force applied to the legs of the user. In an embodiment, the driving modules 35 and 45 may include the first driving module 45 disposed at a position corresponding to a right hip joint of the user and the second driving module 35 disposed at a position corresponding to a left hip joint of the user. The first driving module 45 may include a first actuator and a first joint member and the second driving module 35 may include a second actuator and a second joint member. The first actuator may provide power transferred to the first joint member and the second actuator may provide power transferred to the second joint member. The first actuator and the second actuator may each include a motor configured to generate power (or torque) by receiving power from the battery. When the motor is driven as the power is supplied to the motor, the motor may generate a force (an assistance force) for assisting a body motion of the user or a force (a resistance force) for hindering a body motion of the user. In an embodiment, the control module may adjust the strength and direction of the force generated by the motor by adjusting a voltage and/or a current supplied to the motor.

In an embodiment, the first joint member and the second joint member may receive power from the first actuator and the second actuator, respectively, and may apply an external force to the body of the user based on the received power. In an embodiment, the first joint member and the second joint member may be disposed at positions corresponding to joints of the user, respectively. One side of the first joint member may be directly or indirectly connected to the first actuator and the other side of the first joint member may be directly or indirectly connected to the first torque transmission frame 55. The first joint member may be rotated by the power received from the first actuator. An encoder or a hall sensor that may operate as an angle sensor to measure a rotation angle (corresponding to a joint angle of the user) of the first joint member or the first torque transmission frame 55 may disposed on one side of the first joint member. One side of the second joint member may be connected to the second actuator and the other side of the second joint member may be connected to the second torque transmission frame 50. The second joint member may be rotated by the power received from the second actuator. An encoder or a hall sensor that may operate as an angle sensor to measure a rotation angle of the second joint member or the second torque transmission frame 50 may be disposed on one side of the second joint member.

In an embodiment, the first actuator may be disposed in a lateral direction of the first joint member, and the second actuator may be disposed in a lateral direction of the second joint member. A rotation axis of the first actuator and a rotation axis of the first joint member may be spaced apart from each other, and a rotation axis of the second actuator and a rotation axis of the second joint member may also be spaced apart from each other. However, embodiments are not limited thereto, and an actuator and a joint member may share a rotation axis. In an embodiment, each actuator may be spaced apart from a corresponding joint member. In this case, the driving module 35 or 45 may further include a power transmission module (not shown) configured to transmit power from the actuator to the joint member. The power transmission module may be a rotary body, such as a gear, or a longitudinal member, such as a wire, a cable, a string, a spring, a belt, or a chain. However, the scope of the embodiment is not limited by the positional relationship between an actuator and a joint member and the power transmission structure described above.

In an embodiment, when the wearable device 100 is worn on the user's legs, the first torque transmission frame 55 and the second torque transmission frame 50 may transmit torque generated by the first driving module 45 and the second driving module 35 to the body (e.g., legs) of the user, respectively. The transmitted torque may function as an external force applied to a leg motion of the user. Respective ends of the first torque transmission frame 55 and the second torque transmission frame 50 may be directly or indirectly connected to the joint member and may rotate. As the other ends of the first torque transmission frame 55 and the second torque transmission frame 50 are directly or indirectly connected to the first thigh fastener 2 and the second thigh fastener 1, respectively, the first torque transmission frame 55 and the second torque transmission frame 50 may transmit the torque generated by the first driving module 45 and the second driving module 35 to the user's thighs while supporting the user's thighs. For example, the first torque transmission frame 55 and the second torque transmission frame 50 may push or pull the user's thighs. The first torque transmission frame 55 and the second torque transmission frame 50 may extend in a longitudinal direction of the user's thighs or may be bent and enclose at least some portions of the circumferences of the user's thighs. The first torque transmission frame 55 may be a torque transmission frame for transmitting torque to the right leg of the user and the second torque transmission frame 50 may be a torque transmission frame for transmitting torque to the left leg of the user.

The first thigh fastener 2 and the second thigh fastener 1 may be directly or indirectly connected to the first torque transmission frame 55 and the second torque transmission frame 50, respectively, and may fasten the wearable device 100 to the legs (specifically, thighs) of the user. For example, the first thigh fastener 2 may be a thigh fastener for fastening the wearable device 100 to the right thigh of the user, and the second thigh fastener 1 may be a thigh fastener for fastening the wearable device 100 to the left thigh of the user.

In an embodiment, the first thigh fastener 2 may include a first cover, a first fastening frame, and a first strap, and the second thigh fastener 1 may include a second cover, a second fastening frame, and a second strap. The first cover and the second cover may apply torques generated by the first driving module 45 and the second driving module 35 to the user's thighs, respectively. For example, the first cover and the second cover may be respectively disposed on respective sides of the user's thighs and may push or pull the user's thighs. The first cover and the second cover may be disposed in the circumferential directions of the thighs of the user. The first cover and the second cover may extend to both sides from the other ends of the first torque transmission frame 55 and the second torque transmission frame 50 and may include curved surfaces corresponding to the thighs of the user. The respective ends of the first cover and the second cover may be directly or indirectly connected to the first fastening frame and the second fastening frame. The other ends of the first cover and the second cover may be directly or indirectly connected to the first strap and the second strap.

For example, the first fastening frame and the second fastening frame may be disposed to enclose at least some portions of the circumferences of the user's thighs, thereby the user's thighs may be prevented from being separated from the wearable device 100 or a possibility of separation may decrease. The first fastening frame may have a fastening structure that connects the first cover to the first strap, and the second fastening frame may have a fastening structure that connects the second cover to the second strap.

The first strap may enclose the remaining portion of the circumference of the right thigh of the user that is not covered by the first cover and the first fastening frame, and the second strap may enclose the remaining portion of the circumference of the left thigh of the user that is not covered by the second cover and the second fastening frame. The first and second straps may include, for example, an elastic material (e.g., a band).

FIGS. 5A and 5B are diagrams illustrating a configuration of a control system of a wearable device, according to an embodiment.

Referring to FIG. 5A, the wearable device 100 may include a control module 510 (including a control circuitry, such as a processing circuitry), a communication module 516 including a communication circuit, a sensor module 520 including at least one sensor, a driving module 530, an input module including a circuit, and a sound output module 550 including a speaker. The driving module 530 may include a motor 534 configured to generate power (e.g., torque) and a motor driver circuit 532 configured to drive the motor 534. Although FIG. 5A illustrates the driving module 530 including one motor driver circuit 532 and one motor 534, the example of FIG. 5A is merely an example. Referring to FIG. 5B, in a control system 500-1, a plurality (two or more) of motor driver circuits 532 and 532-1 and a plurality (two or more) of motors 534 and 534-1 may be provided. The driving module 530 including the motor driver circuit 532 and the motor 534 may correspond to the first driving module 45 of FIG. 3 and the driving module 530-1 including the motor driver circuit 532-1 and the motor 534-1 may correspond to the second driving module 35 of FIG. 3. The following descriptions of the motor driver circuit 532 and the motor 534 may also be respectively applicable to the motor driver circuit 532-1 and the motor 534-1 shown in FIG. 5B.

The sensor module 520 may include at least one sensor configured to obtain sensor data. The sensor module 520 may transmit the obtained sensor data to the control module 510. The sensor module 520 may include an inertial sensor 522, a first angle sensor 524, a second angle sensor 524-1, a first distance sensor 570, and a second distance sensor 575 as shown in FIG. 5B. A plurality of sensors described above may be provided and some (e.g., the second distance sensor 575) of them may be omitted. For example, the first distance sensor 570 may include a first distance sensor configured to obtain sensor data related to a distance from the left side of the user to the ground and a first distance sensor configured to obtain sensor data related to the right side of the user to the ground. The second distance sensor 575 may include a second distance sensor configured to obtain sensor data related to a distance from the left side of the user to the ground and a second distance sensor configured to obtain sensor data related to the right side of the user to the ground.

The inertial sensor 522 may measure an upper body motion value of the user. For example, the inertial sensor 522 may sense the acceleration and angular velocity of an X-axis, a Y-axis, and a Z-axis according to a motion of the user. The upper body motion value of the user may correspond to a motion value of a waist support frame (e.g., the waist support frame 20 of FIGS. 3 and 4) of the wearable device 100. The inertial sensor 522 may be disposed on a printed circuit board (PCB) in the base body 80 of the wearable device 100 and may measure a signal indicating a degree of tilting of the wearable device 100. The processor 512 may measure a horizontal balance state of the wearable device 100 by analyzing a signal measured by the inertial sensor 522.

The first angle sensor 524 and the second angle sensor 524-1 may measure a hip joint angle according to the leg motion of the user. The first angle sensor 524 may sense a hip joint angle of the right leg of the user and the second angle sensor 524-1 may sense a hip joint angle of the left leg of the user. The first angle sensor 524 and the second angle sensor 524-1 may include, for example, an encoder and/or a hall sensor. The hip joint angle of the right leg sensed by the first angle sensor 524 may correspond to a motion value (e.g., a rotation angle value) of the first torque transmission frame 55 of the wearable device and the hip joint angle of the left leg sensed by the second angle sensor 524-1 may correspond to a motion value (e.g., a rotation angle value) of the second torque transmission frame 50 of the wearable device.

The first distance sensor 570 and the second distance sensor 575 may measure a signal to calculate a distance from the wearable device 100 to the ground. The first distance sensor 570 may measure a signal related to a first distance from the wearable device 100 to a first ground point, and the second distance sensor 575 may measure a signal related to a second distance from the wearable device 100 to a second ground point that is different from the first ground point. The first ground point may be a point in which output light output by the first distance sensor 570 is reflected by the ground and the second ground point may be a point in which output light output by the second distance sensor 575 is reflected by the ground. The processor 512 may calculate a distance to the ground by analyzing the measured signal. the first distance sensor 570 and the second distance sensor 575 may both measure a signal to calculate the distance from the wearable device 100 to the ground, but measuring directions may be different from each other. The first distance sensor 570 may measure a signal related to a first measure distance from the first ground point positioned in a forward direction than the second ground point. For example, the first distance sensor 570 may measure a signal related to a distance in a direction perpendicular to the ground and the second distance sensor 575 may measure a signal related to a distance in a forward and downward direction. However, the example is not limited thereto.

In an embodiment, the sensor module 520 may further include at least one of a torque sensor configured to sense a torque value, a position sensor configured to obtain a position value of the wearable device 100, a proximity sensor configured to sense the proximity of an object, a biosignal sensor configured to detect a biosignal of the user, and/or a temperature sensor configured to measure an ambient temperature.

Referring back to FIG. 5A, an input module 540 may receive, from the outside (e.g., the user) of the wearable device, a command or data to be used for a component (e.g., the processor 512) of the wearable device. The input module 540 may include, for example, a key (e.g., a button) and/or a touch screen.

The sound output module 550 may output a sound signal to the outside of the wearable device. The sound output module 550 may include a guide sound signal (e.g., a driving start sound or an operation error notification sound) and a speaker for playing music content or guiding voice.

In an embodiment, the control system 500 may include a battery (not shown) to supply power to each component of the wearable device. The wearable device may convert the power of the battery into power suitable for an operating voltage of each component of the wearable device and supply the converted power to each component.

The driving module 530 may generate an external force to be applied to the user's legs by control of the control module 510. The driving module 530 may be in a position corresponding to a position of a hip joint of the user and may generate torque to be applied to the user's legs based on a control signal generated by the control module 510. The control module 510 may transmit the control signal to the motor driver circuit 532, and the motor driver circuit 532 may control an operation of the motor 534 by generating a current signal (or a voltage signal) corresponding to the control signal and supplying the current signal (or the voltage signal) to the motor 534. The current signal may not be supplied to the motor 534 according to the control signal. When the current signal is supplied to the motor 534, and the motor is driven, the motor 534 may generate an assistance force to assist a leg motion of the user or a resistance force to impede the leg motion of the user.

The control module 510 may control an overall operation of the wearable device, and may generate a control signal to control each component of the wearable device. The control module 510 may include at least one processor 512 and a memory 514.

The processor 512 may execute, for example, software to control at least one other component (e.g., a hardware or software component) of the wearable device directly or indirectly connected to the processor 512, and may perform a variety of data processing or computation. According to an embodiment, as at least a part of data processing or computation, the processor 512 may store instructions or data received from another component (e.g., the communication module 516) in the memory 514, may process the instructions or the data stored in the memory 514, and may store result data in the memory 514. The processor 512 may include at least one processor and the operations of the wearable device 100 described herein may be performed by one processor or a combination of multiple processors. According to an embodiment, the processor 512 may include at least one of a main processor (e.g., a central processing unit (CPU) or an application processor (AP)) and/or an auxiliary processor (e.g., a graphics processing unit (GPU), a neural processing unit (NPU), an image signal processor (ISP), a sensor hub processor, or a communication processor (CP)) that is operable independently of or in conjunction with the main processor. The processor 512 may be implemented as a system on chip (SoC) configured to perform processing or an integrated circuit (IC). The auxiliary processor may be implemented separately from the main processor or as a part of the main processor.

The memory 514 may store a variety of data used by at least one component (e.g., the processor 512) of the control module 510. The variety of data may include, for example, software, sensor data, input data, or output data for instructions related thereto. The memory 514 may include at least one of instructions executable by the processor 512. The memory 514 may include at least one memory and the instructions to control the processor 512 to control the operations of the wearable device 100 described herein may be stored in one memory or may be divided and stored in multiple memories. The memory 514 may include volatile memory or non-volatile memory.

The communication module 516 may support establishing a direct (e.g., wired) communication channel or a wireless communication channel between the control module 510 and another component of the wearable device or an external electronic device (e.g., the electronic device 210 or the other wearable device 220 of FIG. 2), and performing communication via the established communication channel. For example, the communication module 516 may transmit the sensor data obtained by the sensor module 520 to an external electronic device (e.g., the electronic device 210 of FIG. 2) and receive a control signal from the external electronic device. The communication module 516 may include one or more CPs that are operable independently of the processor 512 and that support a direct (e.g., wired) communication or a wireless communication. According to an embodiment, the communication module 516 may include a wireless communication module (e.g., a cellular communication module, a short-range wireless communication module, or a global navigation satellite system (GNSS) communication module), and/or a wired communication module. The wireless communication module may communicate with another component of the wearable device 100 and/or an external device via, for example, Bluetooth™, wireless fidelity (Wi-Fi), advanced and adaptive network technology (ANT) or infrared data association (IrDA), a legacy cellular network, a 5G network, a next-generation network, the Internet, or a computer network (e.g., a local area network (LAN) or a wide area network (WAN)).

The haptic module 560 may provide haptic feedback to the user under the control of the processor 512. The haptic module 560 may include one or a plurality of haptic actuators. The haptic actuator may include, for example, a piezo actuator, a bander type actuator, and/or a vibration motor-based actuator. One or a plurality of haptic actuators may be provided. In an embodiment, the haptic actuator may be disposed in at least one of a base body (e.g., the base body 80 of FIG. 3), a torque transmission frame (e.g., the first torque transmission frame 55 and the second torque transmission frame 50 of FIG. 3), and a thigh fastener (e.g., the first thigh fastener 2 and the second thigh fastener 1 of FIG. 3) of the wearable device 100.

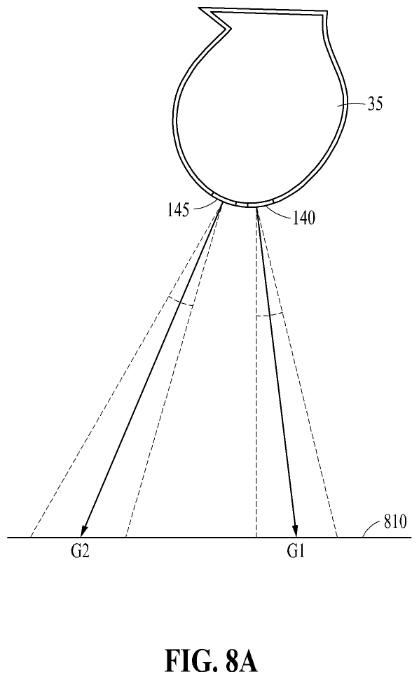

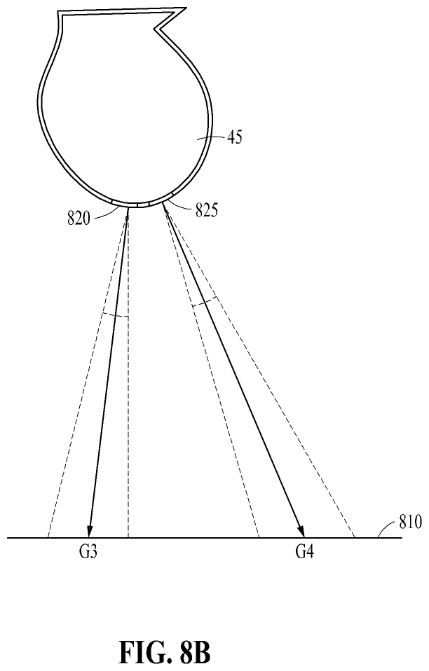

The wearable device 100 according to an embodiment may include at least one driving module (e.g., the driving modules 530 and 530-1) including a motor (e.g., the motors 534 and 534-1) configured to generate torque, a torque transmission frame (e.g., the first torque transmission frame 55 and the second torque transmission frame 50 of FIG. 3) configured to transmit generated torque to the leg of the user wearing the wearable device 100, a fastener (e.g., the first thigh fastener 2 and the second thigh fastener 1 of FIG. 3) connected, directly or indirectly, to the torque transmission frame and configured fasten the wearable device 100 to the leg of the user, and at least one processor (e.g., the processor 512) configured to control an operation of the wearable device 100. The wearable device 100 may further include at least one memory (e.g., the memory 514) configured to store instructions executable by the at least one processor. When at least a portion of the executable instructions stored in the at least one memory is executed by the at least one processor, the executed portion of instructions may cause the wearable device 100 to perform at least one operation of the wearable device 100 described herein. The wearable device 100 may further include at least one of the first distance sensor 570 (e.g., the distance sensor 140 of FIG. 8A or a distance sensor 820 of FIG. 8B) configured to measure a signal related to a first distance from the wearable device 100 to a first ground point and the second distance sensor 575 (e.g., the distance sensor 145 of FIG. 8A or a distance sensor 825 of FIG. 8B) configured to measure a signal related to a second distance from the wearable device 100 to a second ground point that is different from the first ground point. The process of the wearable device 100 to perform detection of a terrain type and a control function based on the detected terrain type are as follows.

At least one processor may determine a first measurement distance from the wearable device 100 to the first ground point based on a signal measured by the first distance sensor 570. For example, the at least one processor may determine the first measurement distance based on a phase difference (or a time taken from a time point when output light is output to a time point when reflected light is detected) between output light, which is output by the first distance sensor 570 toward the first ground point, and reflected light, which returns as the output light is reflected by the ground of the first ground point. When the phase difference between the output light and the reflected light (or the time taken from the time point when the output light is output to the time point when the reflected light is detected) and the velocity of light are given, the first measurement distance may be calculated according to a ToF distance calculation method.

The at least one processor may determine a second measurement distance from the wearable device to the second ground point based on a signal measured by the second distance sensor 575. For example, the at least one processor may determine the second measurement distance based on a phase difference (or a time taken from a time point when output light is output to a time point when reflected light is detected) between output light, which is output by the second distance sensor 575 toward the second ground point, and reflected light, which returns as the output light is reflected by the ground of the second ground point. The second measurement distance may be calculated according to the ToF distance calculation method.

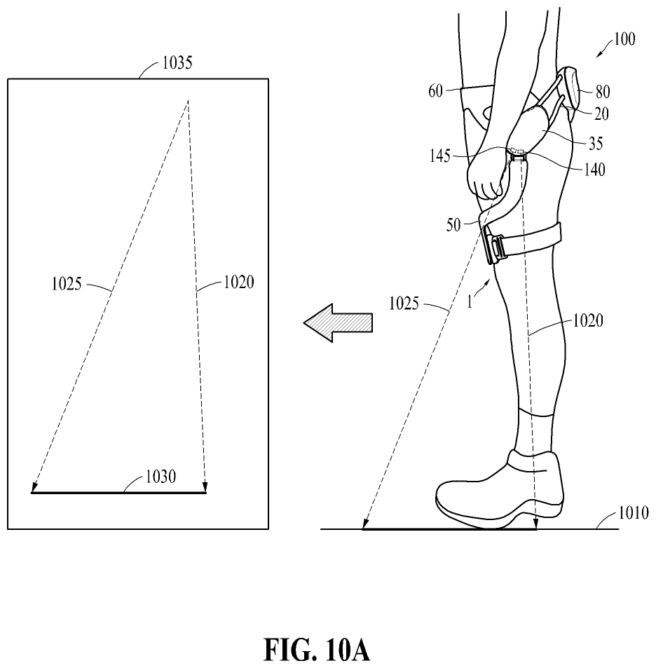

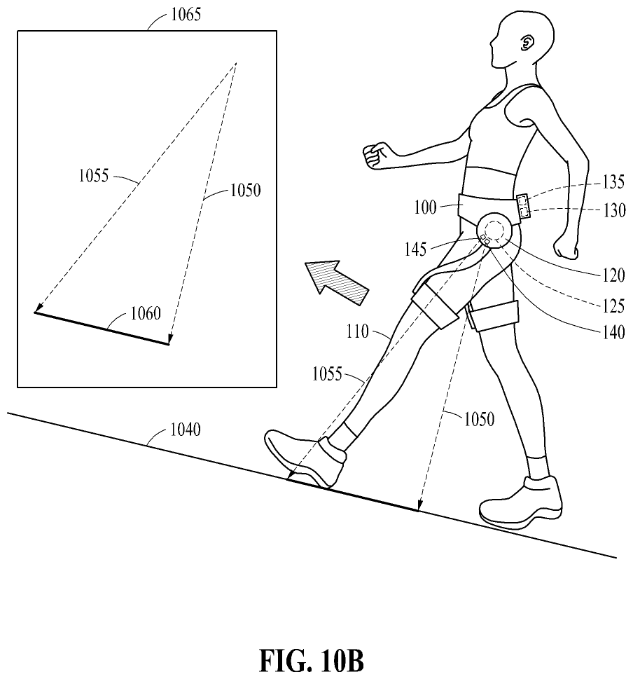

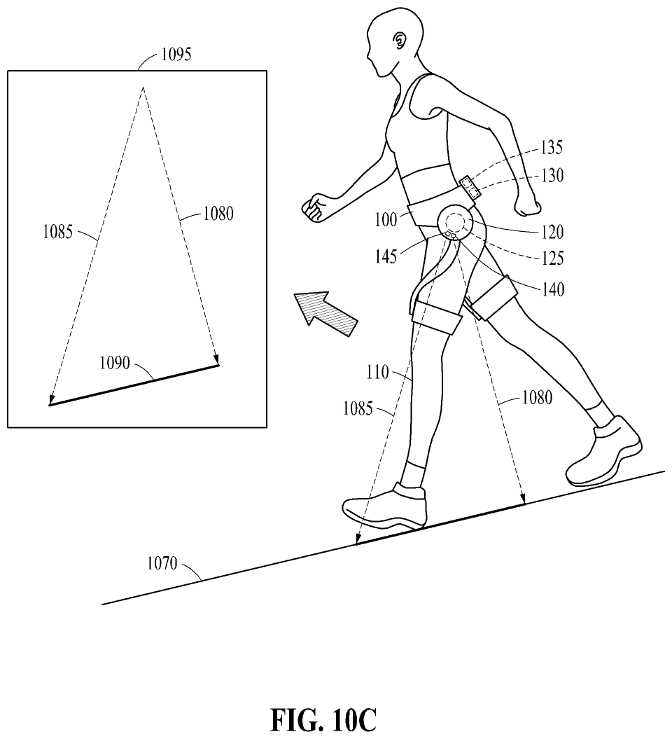

The at least one processor may estimate a terrain type of the ground on which the user is located based on the determined first measurement distance and the determined second measurement distance. For example, the at least one processor may estimate the terrain type of the ground on which the user is located as one of a flat ground, an uphill terrain, and a downhill terrain, based on the determined first measurement distance and the determined second measurement distance. However, the terrain type is not limited thereto. The at least one processor may estimate the terrain type of the ground on which the user is located based on a first reference distance determined based on a signal measured by the first distance sensor 570 when the user is on a reference terrain (e.g., flat ground), a second reference distance determined based on a signal measured by the second distance sensor 575 when the user is on the reference terrain, the first measurement distance, and the second measurement distance. The at least one processor may estimate the terrain type of the ground on which the user is located based on a comparison result between a reference ground length determined based on the first reference distance and the second reference distance and a measurement ground length determined based on the first measurement distance and the second measurement distance. The determination of the reference ground length and the measurement ground length is further described with reference to FIGS. 10A, 10B, and 10C.

The at least one processor may control at least one driving module based on the estimated terrain type. The at least one processor may control to change a magnitude of torque generated by the at least one driving module and an operation mode of the at least one driving module based on the estimated terrain type. The examples of change are as follows.

When the operation mode of the at least one driving module is in an assistance mode for generating an assistance force to assist a leg motion of the user and the terrain type of the ground on which the user is located is estimated as an uphill terrain, the at least one processor may control to increase the magnitude of the assistance force generated by the at least one driving module.

When the operation mode of the at least one driving module is in the assistance mode and the terrain type of the ground on which the user is located is estimated as a downhill terrain, the at least one processor may control the operation mode of the at least one driving module to change to a resistance mode for generating a resistance force to hinder a leg motion of the user or may control to stop generating the assistance force.

When the operation mode of the at least one driving module is in the resistance mode for hindering a resistance force to hinder a leg motion of the user and the terrain type of the ground on which the user is located is estimated as a downhill terrain, the at least one processor may control to increase the magnitude of the resistance force generated by the at least one driving module.

When the operation mode of the at least one driving module is in the resistance mode and the terrain type of the ground on which the user is located is estimated as an uphill terrain, the at least one processor may control the operation mode of the at least one driving module to change to the assistance mode for generating the assistance force to assist a leg motion of the user or may control to stop generating the resistance force.

When the operation mode of the at least one driving module is in a non-torque mode in which torque is not generated and the terrain type of the ground on which the user is located is estimated as an uphill terrain, the at least one processor may control the operation mode of the at least one driving module to change to the assistance mode for generating the assistance force to assist a leg motion of the user. When the operation mode of the at least one driving module is in the non-torque mode and the terrain type of the ground on which the user is located is estimated as a downhill terrain, the at least one processor may control the operation mode of the at least one driving module to change to the resistance mode for generating the resistance force to hinder a leg motion of the user.

The wearable device 100 according to an embodiment may include at least one driving module (e.g., the driving modules 530 and 530-1) including a motor (e.g., the motors 534 and 534-1) configured to generate torque, a torque transmission frame (e.g., the first torque transmission frame 55 and the second torque transmission frame 50 of FIG. 3) configured to transmit generated torque to the leg of the user wearing the wearable device 100, a fastener (e.g., the first thigh fastener 2 and the second thigh fastener 1 of FIG. 3) connected, directly or indirectly, to the torque transmission frame and configured fasten the wearable device 100 to the leg of the user, and at least one processor (e.g., the processor 512) configured to control an operation of the wearable device 100. The wearable device 100 may further include the first distance sensor 570 (e.g., the distance sensor 140 of FIG. 8A or the distance sensor 820 of FIG. 8B) configured to measure a signal related to a distance from the wearable device 100 to the first ground point. The process of the wearable device 100 to perform the wearing state detection function is as follows.

In an embodiment, the wearable device 100 may perform the wearing state detection function using the first distance sensor 570. At least one processor may determine a first measurement distance from the wearable device 100 to the first ground point based on a signal measured by the first distance sensor 570. The at least one processor may determine whether to output wearing guide content to induce normal wearing of the wearable device 100 based on the determined first measurement distance. The first measurement distance may be a distance measured by using the first distance sensor 570 while the user wears the wearable device 100 and may correspond to a wearing position (or a wearing height) in which the user wears the wearable device 100. Preferably, the first measurement distance may correspond to a distance from the ground to the wearable device 100 (e.g., or the first distance sensor 570) in a direction perpendicular to the ground, but the example is not limited thereto. When the first measurement distance is not included in a preset reference distance range, the at least one processor may determine to output the wearing guide content, and when the first measurement distance is included in the preset reference distance range, the at least one processor may determine not to output the wearing guide content. For example, the reference distance range may be a distance range with a reference distance measured by the first distance sensor 570 as a median based on an assumption that the user wears the wearable device 100 in the appropriate wearing position. The reference distance may be determined during a personalization process of the wearable device 100 for the user 110 or a reference distance measurement process performed in response to the user's request. The wearable device 100 may further include the sound output module 550 including a speaker and the at least one processor may control the sound output module 550 to output the wearing guide content corresponding to audio content in response to the determination to output the wearing guide content.

In an embodiment, the wearable device 100 may further include the second distance sensor 575 configured to measure a signal related to the second measurement distance from the wearable device 100 to the second ground point that is different from the first ground point. The wearable device 100 may perform the wearing state detection function using the first distance sensor 570 and the second distance sensor 575. In an embodiment, the first distance sensor 570 may be positioned in a housing of a first driving module (e.g., the first driving module 45 of FIG. 3) positioned at a point corresponding to a first hip joint position of the user and the second distance sensor 575 may be positioned in a housing of a second driving module (e.g., the second driving module 35 of FIG. 3) positioned at a point corresponding to a second hip joint position of the user that is different from the first hip joint position. In this case, the first distance sensor 570 may measure a signal related to a distance from the wearable device 100 to the first ground point of the ground at a location where the first driving module is positioned (e.g., the right side of the user) and the second distance sensor 575 may measure a signal related to a distance from the wearable device 100 to the second ground point of the ground at a location where the second driving module is positioned (e.g., the left side of the user). For example, if the first distance sensor 570 corresponds to the distance sensor 820 of FIG. 8B, the second distance sensor 575 may correspond to the distance sensor 140 of FIG. 8A. The at least one processor may determine the first measurement distance from the wearable device 100 to the first ground point based on the signal measured by the first distance sensor 570 and may determine the second measurement distance from the wearable device 100 to the second ground point based on the signal measured by the second distance sensor 575. The first measurement distance may correspond to a wearing position of the wearable device 100 on the right side of the user, and the second measurement distance may correspond to a wearing position of the wearable device 100 on the left side of the user. The at least one processor may determine whether to output the wearing guide content based on the first measurement distance and the second measurement distance. For example, when a difference between the first measurement distance and the second measurement distance is not included in a threshold range, the at least one processor may determine to output the wearing guide content. For example, the threshold range may be a preset range with 0 as a median. For example, when the difference between the first measurement distance and the second measurement distance is included in the threshold range, the at least one processor may determine not to output the wearing guide content. When the user wears the wearable device 100 horizontally in balance, the first measurement distance may be the same as the second measurement distance, and thereby, the difference between the first measurement distance and the second measurement distance may be “0”. Based on the characteristics described above, whether the user wears the wearable device 100 horizontally in balance or the wearable device 100 is obliquely worn may be distinguished by comparing the first measurement distance with the second measurement distance.

In an embodiment, the wearable device 100 may further include the inertial sensor 522 configured to measure a signal related to a tilting degree of the wearable device 100. The wearable device 100 may perform the wearing state detection function using the first distance sensor 570 and the inertial sensor 522. As described above, the at least one processor may determine the first measurement distance from the wearable device 100 to the first ground point based on the signal measured by the first distance sensor 570 (e.g., the distance sensor 140 of FIG. 8A or the distance sensor 820 of FIG. 8B) and may determine whether the wearable device 100 is worn at an appropriate height based on whether the determined first measurement distance is included in a preset reference distance range. In addition, the at least one processor may determine the tilting degree of the wearable device 100 based on a signal measured by the inertial sensor 522 and may determine whether to output the wearing guide content to induce normal wearing of the wearable device 100 based on the determined tilting degree. For example, when the tilting degree is not included in a threshold range, the at least one processor may determine to output the wearing guide content. For example, the threshold range may be a preset range with 0 as a median. When the tilting degree is included in the threshold range, the at least one processor may determine not to output the wearing guide content. For example, the inertial sensor 522 may be disposed on the middle of the left and right sides of the user's waist and may sense a tilting angle, and when the wearable device 100 is worn horizontally in balance, the tilting angle may be 0 or a value close to 0. Based on the characteristic described above, whether the user wears the wearable device 100 horizontally in balance or the wearable device 100 is obliquely worn may be distinguished based on the tilting degree measured by the inertial sensor 522.

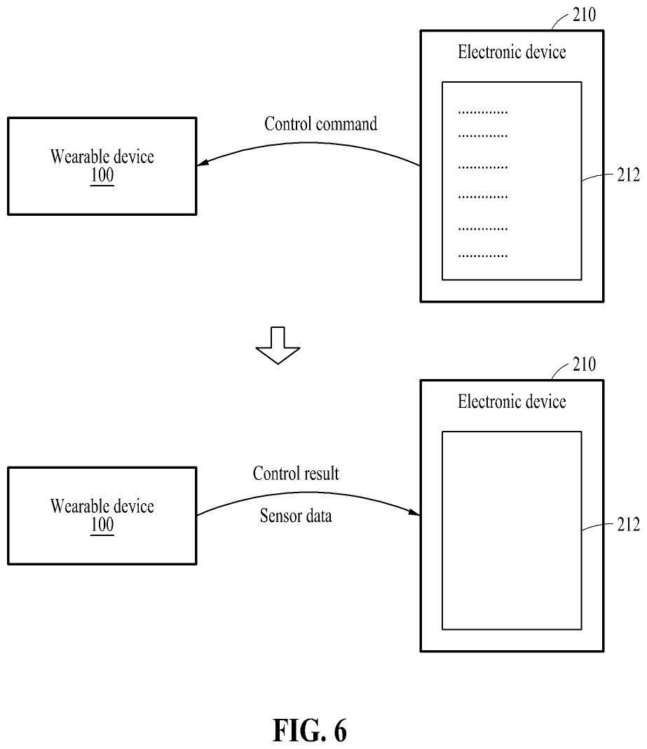

FIG. 6 is a diagram illustrating an interaction between a wearable device and an electronic device according to an embodiment.

Referring to FIG. 6, the wearable device 100 may communicate with the electronic device 210. For example, the electronic device 210 may be a user terminal of a user of the wearable device 100. In an embodiment, the wearable device 100 and the electronic device 210 may be connected to each other via short-range wireless communication (e.g., Bluetooth™ or Wi-Fi communication).

In an embodiment, the electronic device 210 may check a state of the wearable device 100 or execute an application to control or operate the wearable device 100. A screen of a user interface (UI) may be displayed to control an operation of the wearable device 100 or determine an operation mode of the wearable device 100 on a display 212 of the electronic device 210 through the execution of the application. The UI may be, for example, a graphical user interface (GUI).

In an embodiment, the user may input an instruction for controlling the operation of the wearable device 100 (e.g., an execution instruction to a walking assistance mode or an exercise assistance mode) or may change settings of the wearable device 100 through a GUI screen on the display 212 of the electronic device 210. The electronic device 210 may generate a control instruction (or control signal) corresponding to an operation control instruction or a setting change instruction input by the user and transmit the generated control instruction to the wearable device 100. The wearable device 100 may operate according to the received control instruction and transmit a control result according to the control instruction and/or sensor data measured by the sensor module of the wearable device 100 to the electronic device 210. The electronic device 210 may provide the user with result information (e.g., current exercise status information, exercise result information, exercise posture assessment information, and physical ability assessment information) derived by analyzing the control result and/or sensor data through the GUI screen.

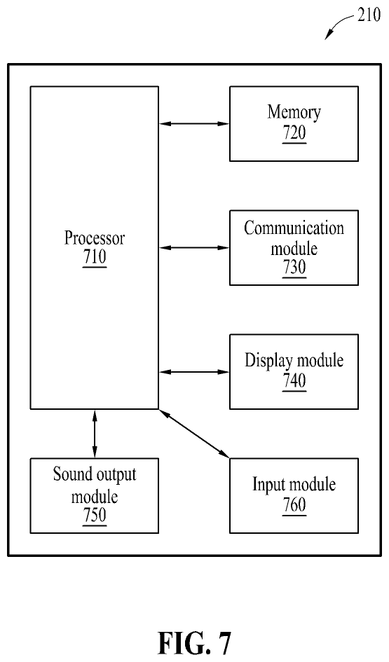

FIG. 7 is a diagram illustrating a configuration of an electronic device according to an embodiment.

Referring to FIG. 7, the electronic device 210 may include a processor 710, a memory 720, a communication module 730, a display module 740, a sound output module 750, and an input module 760. In an embodiment, at least one of the components (e.g., the sound output module 750) may be omitted from the electronic device 210, or one or more other components (e.g., a sensor module, a haptic module, and a battery) may be added to the electronic device 210.

The processor 710 may control at least one other component (e.g., a hardware or software component) of the electronic device 210 and may perform various types of data processing or operations. In an embodiment, as at least a part of data processing or operations, the processor 710 may store instructions or data received from another component (e.g., the communication module 730) in the memory 720, process the instructions or the data stored in the memory 720, and store result data in the memory 720. The processor 710 may include at least one processor and the operations of the electronic device 210 described herein may be performed by one processor or a combination of multiple processors.

In an embodiment, the processor 710 may include at least one of a main processor (e.g., a CPU or an AP) or an auxiliary processor (e.g., a GPU, an NPU, an ISP, a sensor hub processor, or a CP) that is operable independently of or in conjunction with the main processor. The processor 710 may be implemented as an SoC configured to perform processing or an IC.

The memory 720 may store various pieces of data used by at least one component (e.g., the processor 710 or the communication module 730) of the electronic device 210. The data may include, for example, a program (e.g., an application) and input data or output data for a command related thereto. The memory 720 may include at least one instruction executable by the processor 710. The memory 720 may include at least one memory and the instructions to control the processor 710 to control the operations of the wearable device and/or electronic device 210 described herein may be stored in one memory or may be divided and stored in multiple memories. The memory 720 may include, for example, volatile memory or non-volatile memory.

The communication module 730 may support establishing a direct (e.g., wired) communication channel or a wireless communication channel between the electronic device 210 and another electronic device (e.g., the wearable device 100, the other wearable device 220, or the server 230) and performing communication via the established communication channel. The communication module 730 may include a communication circuit for performing a communication function. The communication module 730 may include one or more CPs that are operable independently of the processor 710 (e.g., an AP) and that support a direct (e.g., wired) communication or a wireless communication. In an embodiment, the communication module 730 may include a wireless communication module (e.g., a Bluetooth™ communication module, a cellular communication module, a Wi-Fi communication module, or a GNSS communication module) that performs wireless communication or a wired communication module (e.g., a LAN communication module or a power line communication (PLC) module). For example, the communication module 730 may transmit a control instruction to the wearable device 100 and receive, from the wearable device 100, at least one of sensor data including body motion information of the user who is wearing the wearable device 100, state data of the wearable device 100, or control result data corresponding to the control instruction.

The display module 740 may visually provide information to the outside (e.g., the user) of the electronic device 210. The display module 740 may include, for example, a light-emitting diode (LCD) or organic light-emitting diode (OLED) display, a hologram device, or a projector device. The display module 740 may further include a control circuit to control the driving of the display. In an embodiment, the display module 740 may further include a touch sensor set to sense a touch or a pressure sensor set to sense the intensity of a force generated by the touch. The display module 740 may output a UI screen to control the wearable device 100 or provide various pieces of information (e.g., exercise evaluation information or setting information of the wearable device 100).

The sound output module 750 may output a sound signal to the outside of the electronic device 210. The sound output module 750 may include a speaker configured to play back a guiding sound signal (e.g., an operation start sound or an operation error alarm), music content, or a guiding voice based on the state of the wearable device 100. For example, when it is determined that the wearable device 100 is not normally worn on the body of the user, the sound output module 750 may output a guiding voice for notifying the user of abnormal wearing of the wearable device 100 or guiding the user to wear the wearable device 100 normally.

The input module 760 may receive a command or data to be used by a component (e.g., the processor 710) of the electronic device 210, from the outside (e.g., the user) of the electronic device 210. The input module 760 may include an input component circuit and receive a user input. The input module 760 may include, for example, a touch recognition circuit for recognizing a touch on a key (e.g., a button) and/or a screen.

In an embodiment, the communication module 730 may receive, from the wearable device 100, a signal measured by a distance sensor (e.g., the first distance sensor 140 and the second distance sensor 145 of FIG. 1) of the wearable device 100 and the processor 710 may determine a distance from the wearable device 100 to the ground based on the received signal. Based on the determined distance, the processor 710 may perform detection of a terrain type, a control function based on the detected terrain type, and/or the wearing state detection function of the wearable device 100 described with reference to FIG. 1. In an embodiment, the processor 710 may determine whether a change in an operation mode of the wearable device 100 and/or control including adjustment of the torque magnitude is required based on an estimated terrain type and may generate a control signal to request the wearable device 100 for the control. The generated control signal may be transmitted to the wearable device 100 through the communication module 730. In an embodiment, the processor 710 may determine whether the wearable device 100 is normally worn on the user based on the determined distance. If it is determined that the wearable device 100 is not normally worn on the user, the processor 710 may control the sound output module 750 to output the audio guide to induce normal wearing of the wearable device 100 to the user.

FIGS. 8A and 8B are diagrams illustrating an operation of a distance sensor of a wearable device according to an embodiment.

FIG. 8A illustrates the distance sensors 140 and 145 disposed in a housing of the second driving module 35 according to an embodiment and FIG. 8B illustrates the distance sensors 820 and 825 disposed on a housing of the first driving module 45 according to an embodiment. The distance sensors, 140, 145, 820, and 825 may be, ToF distance sensors.

The distance sensor may be disposed in one of the first driving module 45 and the second driving module 35 or may be disposed in both the first driving module 45 and the second driving module 35. In addition, either one or both of the distance sensors 140 and 145 may be provided and either one or both of the distance sensors 820 and 825 may be provided. In addition, three or more distance sensors may be disposed in the housing of at least one driving module.

Referring to FIG. 8A, the distance sensor 140 may measure a signal related to a distance from the wearable device 100 to a ground point G1 on a ground 810 and the distance sensor 145 may measure a signal related to a distance from the wearable device 100 to a ground point G2 on the ground 810 that is different from the ground point G1. The ground point at which the distance sensor 140 measures the distance may be, preferably, a point at which output light output from the distance sensor 140 in a direction perpendicular to the ground arrives. In this case, a measurement distance calculated from the signal measured by the distance sensor 140 may represent a vertical distance between the distance sensor 140 and the ground. However, the distance sensor 140 may be implemented to measure a distance in not only the vertical direction but also a rear direction (a backward direction of the user), a lateral direction, or a forward direction that is different from a direction in which the distance sensor 145 measures.

The ground point G2 at which the distance sensor 145 measures the distance may be, preferably, a point at which output light, which is output from the distance sensor 145 in a forward and downward direction, reaches. In this case, the measurement distance calculated from the signal measured by the distance sensor 145 may represent a distance from the distance sensor 145 to the ground with respect to a forward direction at a predetermined angle. In this case, the predetermined angle may represent an angle formed by the output light of the distance sensor 140 and the output light of the distance sensor 145 and may have a fixed value (e.g., 35 degrees). However, the distance sensor 145 may be implemented to measure a distance not only in the forward direction but also the backward direction or the lateral direction.

Referring to FIG. 8B, the distance sensor 820 may measure a signal related to a distance from the wearable device 100 to a ground point G3 on the ground 810 and the distance sensor 820 may measure a signal related to a distance from the wearable device 100 to a ground point G4 on the ground 810 that is different from the ground point G3. In an embodiment, the distance sensor 820 may have a difference in an arrangement position and may identically operate as the distance sensor 140 of FIG. 8A. The distance sensor 825 may also have a difference in an arrangement position and may identically operate as the distance sensor 145 of FIG. 8A.

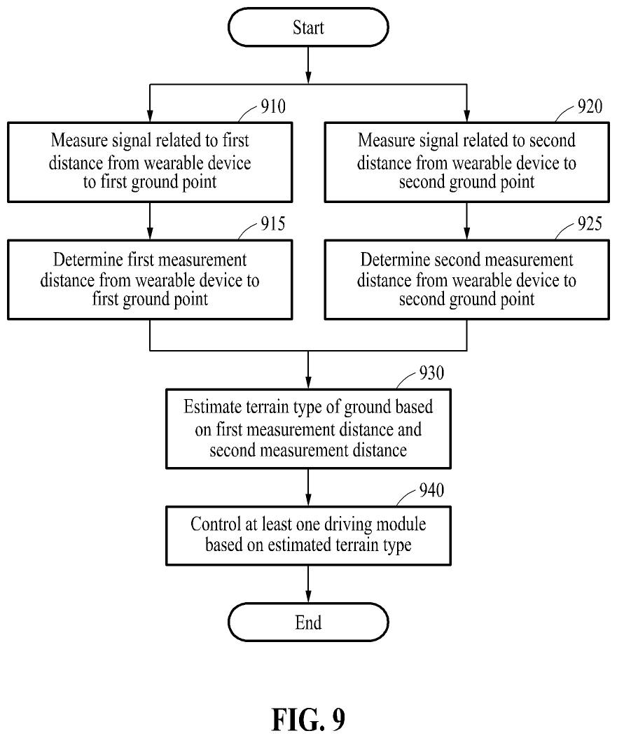

FIG. 9 is a flowchart illustrating operations of a control method of a wearable device performing control based on terrain-type detection according to an embodiment. In an embodiment, at least one of the operations of FIG. 9 may be simultaneously or parallelly performed with one another, and the order of the operations may be changed. In addition, at least one of the operations may be omitted, or another operation may be additionally performed.

Referring to FIG. 9, in operation 910, the wearable device 100 may measure a signal related to a first distance from the wearable device 100 to a first ground point (e.g., the ground point G1 of FIG. 8A or the ground point G3 of FIG. 8B) using a first distance sensor (e.g., the first distance sensor 570 of FIG. 5B).

In operation 920, the wearable device 100 may measure a signal related to a second distance from the wearable device 100 to a second ground point (e.g., the ground point G2 of FIG. 8A or the ground point G4 of FIG. 8B) that is different from the first ground point using a second distance sensor (e.g., the second distance sensor 575 of FIG. 5B). Operations 910 and 920 may be performed in parallel or may be sequentially performed, and there is no limitation on the order of execution.

In operation 915, at least one processor (e.g., the processor 512 of FIGS. 5A and 5B) of the wearable device 100 may determine a first measurement distance from the wearable device 100 to the first ground point based on the signal measured by the first distance sensor. In operation 925, the at least one processor may determine a second measurement distance from the wearable device 100 to the second ground point based on a signal measured by the second distance sensor.

In operation 930, the at least one processor may estimate a terrain type of the ground on which the user is located based on the first measurement distance determined in operation 915 and the second measurement distance determined in operation 925. For example, the at least one processor may estimate the terrain type of the ground on which the user is located as one of a flat ground, an uphill terrain, or a downhill terrain, based on the first measurement distance and the second measurement distance. The at least one processor may estimate the terrain type of the ground on which the user is located based on a first reference distance determined based on a signal measured by the first distance sensor when the user is on a reference terrain (e.g., the flat ground), a second reference distance determined based on a signal measured by the second distance sensor when the user is on the reference terrain, the first measurement distance, and the second measurement distance. The at least one processor may estimate the terrain type of the ground on which the user is located based on a comparison result between a reference ground length determined based on the first reference distance and the second reference distance and a measurement ground length determined based on the first measurement distance and the second measurement distance.

In operation 940, the at least one processor may control at least one driving module (e.g., the driving modules 530 and 530-1 of FIG. 5B) of the wearable device 100 based on the terrain type estimated in operation 930. The at least one processor may control to change a magnitude of torque generated by the at least one driving module and an operation mode of the at least one driving module based on the estimated terrain type.

The estimation of the terrain type in operation 930 and the control of the driving module in operation 940 are further described with reference to FIGS. 10A, 10B, and 10C.

FIGS. 10A, 10B, and 10C are diagrams illustrating a wearable device detecting a terrain type using a distance sensor and performing control based on a detected terrain type according to an embodiment.

According to an embodiment, the wearable device 100 may detect a terrain type of a location where the user is located by comparing measurement distances measured by a distance sensor for terrains having different terrain types and may perform a control based on the detected terrain type. FIG. 10A is a diagram illustrating the determination of a reference distance and a reference ground length according to an embodiment. Referring to FIG. 10A, while the user wears the wearable device 100 and stands on a reference terrain 1010 (e.g., the flat ground), at least one processor (e.g., the processor 512 of FIGS. 5A and 5B) of the wearable device 100 may determine a first reference distance 1020, which is a distance from the wearable device 100 to the reference terrain 1010, by using the first distance sensor 140 and may determine a second reference distance 1025, which is a distance from the wearable device 100 to the reference terrain 1010, by using the second distance sensor 145. Depending on the embodiment, the wearable device 100 may separately measure the first reference distance 1020 and the second reference distance 1025 using the first distance sensor 140 and the second distance sensor 145 or may measure the first reference distance 1020 and the second reference distance 1025 at once through a 3D ToF sensor. A determination process of the first reference distance 1020 and the second reference distance 1025 may be performed during a personalization or test process conducted when the user uses the wearable device 100 for the first time or a reference distance setting process in response to a user's request.

In an embodiment, the reference ground length may be calculated based on the first reference distance 1020 and the second reference distance 1025 using triangulation. A triangle 1035 may be defined based on the first reference distance 1020, the second reference distance 1025, and an estimated angle formed by output light from the first distance sensor 140 and output light from the second distance sensor 145. In the triangle 1035, the first reference distance 1020 and the second reference distance 1025 may correspond to two sides having the estimated angle as a contained angle. Of three sides of the triangle 1035, the length of a remaining side 1030 other than two sides corresponding to the first reference distance 1020 and the second reference distance 1025 may be determined to be the reference ground length. The determined reference ground length may be stored in a storage (e.g., the memory 514 of FIGS. 5A and 5B) of the wearable device 100.

FIG. 10B is a diagram illustrating the detection of a terrain type for an uphill terrain and control according to an embodiment. Referring to FIG. 10B, it is assumed that the user wears the wearable device 100 and walks or exercises on an uphill terrain 1040. At least one processor (e.g., the processor 512 of FIGS. 5A and 5B) of the wearable device 100 may determine a first measurement distance 1050 from the wearable device 100 to a first ground point of the uphill terrain 1040 by using the first distance sensor 140 and may determine a second measurement distance 1055 from the wearable device 100 to a second ground point of the uphill terrain 1040 by using the second distance sensor 145. Depending on the embodiment, the wearable device 100 may separately measure the first measurement distance 1050 and the second measurement distance 1055 using the first distance sensor 140 and the second distance sensor 145 or may measure the first measurement distance 1050 and the second measurement distance 1055 at once through a 3D ToF sensor.

In an embodiment, a measurement ground length may be calculated based on the first measurement distance 1050 and the second measurement distance 1055 using triangulation. A triangle 1065 may be defined based on the first measurement distance 1050, the second measurement distance 1055, and an estimated angle formed by output light from the first distance sensor 140 and output light from the second distance sensor 145. In the triangle 1065, the first measurement distance 1050 and the second measurement distance 1055 may correspond to two sides having the estimated angle as a contained angle. Of three sides of the triangle 1065, the length of a remaining side 1060 other than two sides corresponding to the first measurement distance 1050 and the second measurement distance 1055 may be determined to be the measurement ground length. The at least one processor may recognize that the terrain on which the user is located or a forward terrain of the user is an uphill terrain by comparing the measurement ground length with the determined reference ground length in the reference terrain 1010. The second measurement distance 1055 measured in the uphill terrain 1040 may tend to be shorter than the second reference distance 1025 measured in the reference terrain 1010. Based on a comparison between the triangle 1035 defined by the first reference distance 1020 and the second reference distance 1025 measured in the reference terrain 1010 and the triangle 1065 defined by the first measurement distance 1050 and the second measurement distance 1055 measured in the uphill terrain, the length of the side 1060 of the triangle 1065 may be shorter than the length of the side 1030 of the triangle 1035. Based on the characteristic described above, if the measurement ground length corresponding to the length of the side 1060 is shorter than the reference ground length corresponding to the length of the side 1030, it may be estimated that the terrain type of the ground on which the user is located is the uphill terrain 1040. If the determined measurement ground length is shorter than the reference ground length, the at least one processor may estimate that the user is currently on the uphill terrain 1040 or the forward terrain of the user is the uphill terrain 1040.

In an embodiment, when it is estimated that the user is located on the uphill terrain 1040 after the user walks or exercises on the flat ground or the downhill terrain, examples of the control performed by the wearable device 100 are as follows.

When an operation mode of at least one driving module (e.g., the driving modules 530 and 530-1 of FIG. 5B) of the wearable device 100 is in the assistance mode for generating an assistance force and the terrain type of the ground on which the user is located is estimated as the uphill terrain 1040, the at least one processor may control to increase the magnitude of the assistance force generated by the at least one driving module. When the operation mode of the at least one driving module is in the resistance mode for generating a resistance force and the terrain type of the ground on which the user is located is estimated as the uphill terrain 1040, the at least one processor may control the operation mode of the at least one driving module to change to the assistance mode or may control to stop generating the resistance force. When the operation mode of the at least one driving module is in a non-torque mode in which torque is not generated and the terrain type of the ground on which the user is located is estimated as the uphill terrain 1040, the at least one processor may control the operation mode of the at least one driving module to change to the assistance mode. The change between the assistance mode and the resistance mode may be determined based on a performed exercise program. When an exercise program operated in the resistance mode is performed, and the terrain type of ground on which the user is located is estimated as the uphill terrain 1040, the at least one processor may control the operation mode of the at least one driving module to change from the resistance mode to the non-torque mode.

FIG. 10C is a diagram illustrating the detection of a terrain type for a downhill terrain and control according to an embodiment. Referring to FIG. 10C, it is assumed that the user wears the wearable device 100 and walks or exercises on a downhill terrain 1070. At least one processor (e.g., the processor 512 of FIGS. 5A and 5B) of the wearable device 100 may determine a first measurement distance 1080 from the wearable device 100 to a first ground point of the downhill terrain 1070 by using the first distance sensor 140 and may determine a second measurement distance 1085 from the wearable device 100 to a second ground point of the downhill terrain 1070 by using the second distance sensor 145. Depending on the embodiment, the wearable device 100 may separately measure the first measurement distance 1080 and the second measurement distance 1085 using the first distance sensor 140 and the second distance sensor 145 or may measure the first measurement distance 1080 and the second measurement distance 1085 at once through a 3D ToF sensor.

In an embodiment, a measurement ground length may be calculated based on the first measurement distance 1080 and the second measurement distance 1085 using triangulation. A triangle 1095 may be defined based on the first measurement distance 1080, the second measurement distance 1085, and an estimated angle formed by output light from the first distance sensor 140 and output light from the second distance sensor 145. In the triangle 1095, the first measurement distance 1080 and the second measurement distance 1085 may correspond to two sides having the estimated angle as a contained angle. Of three sides of the triangle 1095, the length of a remaining side 1090 other than two sides corresponding to the first measurement distance 1080 and the second measurement distance 1085 may be determined to be the measurement ground length. The second measurement distance 1085 measured in the downhill terrain 1070 may tend to be longer than the second reference distance 1025 measured in the reference terrain 1010. Based on a comparison between the triangle 1035 defined by the first reference distance 1020 and the second reference distance 1025 measured in the reference terrain 1010 and the triangle 1095 defined by the first measurement distance 1080 and the second measurement distance 1085 measured in the downhill terrain 1070, the length of the side 1090 of the triangle 1095 may be longer than the length of the side 1030 of the triangle 1035. Based on the characteristic described above, if the measurement ground length corresponding to the length of the side 1090 is longer than the reference ground length corresponding to the length of the side 1030, it may be estimated that the terrain type of the ground on which the user is located is the downhill terrain 1070. If the determined measurement ground length is longer than the reference ground length, the at least one processor may estimate that the user is currently on the downhill terrain 1070 or the forward terrain of the user is the downhill terrain 1070.

In an embodiment, when it is estimated that the user is located on the downhill terrain 1070 after the user walks or exercises on the flat ground or the uphill terrain, examples of the control performed by the wearable device 100 are as follows.

When the operation mode of the driving module is in the assistance mode for generating the assistance force and the terrain type of the ground on which the user is located is estimated as the downhill terrain 1070, the at least one processor may control the operation mode of the at least one driving module to change to the resistance mode for generating a resistance force or may control to stop generating the assistance force. When the operation mode of the at least one driving module is in the resistance mode and the terrain type of the ground on which the user is located is estimated as the downhill terrain 1070, the at least one processor may control to increase the magnitude of the resistance force generated by the at least one driving module. When the operation mode of the at least one driving module is in the non-torque mode and the terrain type of the ground on which the user is located is estimated as the downhill terrain 1070, the at least one processor may control the operation mode of the at least one driving module to change to the resistance mode. The change between the assistance mode and the resistance mode may be determined based on a performed exercise program. When an exercise program operated in the assistance mode is performed and the terrain type of ground on which the user is located is estimated as the downhill terrain 1070, the at least one processor may control the operation mode of the at least one driving module to change from the assistance mode to the non-torque mode.

When the user walks or exercises on flat ground, the first measurement distance determined by the first distance sensor 140 and the second measurement distance determined by the second distance sensor 145 may have no or small difference from the first reference distance 1020 and the second reference distance 1025 determined in the reference terrain 1010, respectively. Accordingly, the measurement ground length determined based on the first measurement distance and the second measurement distance on the flat ground may have no or small difference from the reference ground length and the at least one processor may recognize that the user is on the flat ground based on a difference between the measurement ground length and the reference ground length. When it is recognized that the user is on flat ground, the applied operation mode of the at least one driving module and an output pattern of torque may be unchanged and may be maintained.

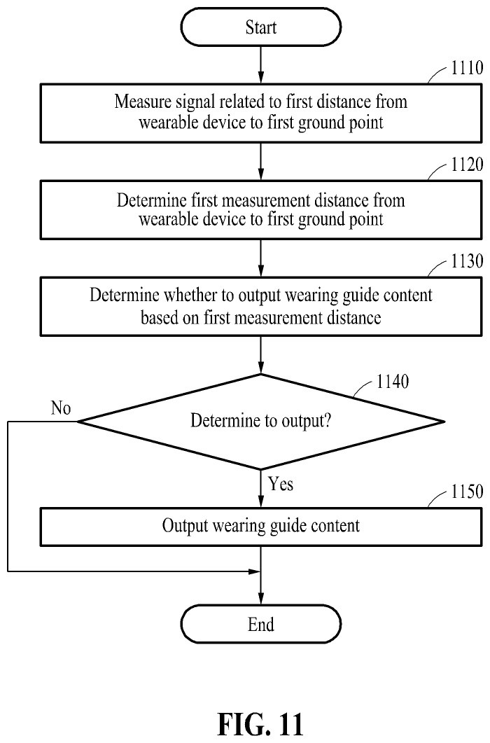

FIG. 11 is a flowchart illustrating operations of a control method of a wearable device performing a wearing state detection function according to an embodiment. In an embodiment, at least one of operations of FIG. 11 may be simultaneously or parallelly performed with one another, and the order of the operations may be changed. In addition, at least one of the operations may be omitted, or another operation may be additionally performed.

Referring to FIG. 11, in operation 1110, the wearable device 100 may measure a signal related to a first distance from the wearable device 100 to a first ground point (e.g., the ground point G1 of FIG. 8A or the ground point G3 of FIG. 8B) using a first distance sensor (e.g., the first distance sensor 570 of FIG. 5B).

In operation 1120, at least one processor (e.g., the processor 512 of FIGS. 5A and 5B) of the wearable device 100 may determine a first measurement distance from the wearable device 100 to the first ground point based on the signal measured by the first distance sensor. The first measurement distance may be a distance measured by using the first distance sensor while the user wears the wearable device 100 and may correspond to a wearing position (or a wearing height) in which the user wears the wearable device 100.

In operation 1130, the at least one processor may determine whether to output wearing guide content to induce normal wearing of the wearable device 100 based on the first measurement distance determined in operation 1120. When the first measurement distance is not included in a preset reference distance range, the at least one processor may determine to output the wearing guide content and when the first measurement distance is included in the preset reference distance range, the at least one processor may determine not to output the wearing guide content. If the first measurement distance is included in the preset reference distance range, it may be estimated that the wearable device 100 is worn in an appropriate wearing position. If the first measurement distance is not included in the preset reference distance range, it may be estimated that the wearable device 100 is not worn in the appropriate wearing position.

Based on the determination in operation 1130, whether an output of the wearing guide content is determined may be determined in operation 1140. If it is determined to output the wearing guide content (“yes” in operation 1140), in operation 1150, the at least one processor may control a sound output module (e.g., the sound output module 550 of FIGS. 5A and 5B) of the wearable device 100 to output the wearing guide content corresponding to audio content. For example, a guiding voice saying, “It seems that the wearable device is worn at a relatively high position. Please check the wearing state.” may be output through the wearable device 100, and the user may adjust the wearing position of the wearable device 100 according to the guiding voice. Each time the user wears the wearable device 100 or performs exercise while wearing the wearable device 100, the wearable device 100 may determine the first measurement distance using the first distance sensor and may monitor the wearing position of the wearable device 100 based on the first measurement distance. When it is determined that the wearable device 100 is not worn in the appropriate wearing position as a monitoring result of the wearing position of the wearable device 100, the wearable device 100 may guide the user to wear the wearable device 100 in the appropriate position by outputting the wearing guide content. The wearable device 100 may also request an electronic device (e.g., the electronic device 210 of FIG. 2) or another wearable device (e.g., the other wearable device 220 of FIG. 2) to output the wearing guide content such that the wearing guide content is output through the electronic device or the other wearable device. In this case, the wearing guide content may include a guiding voice output through a speaker and/or a guide message output on a screen.

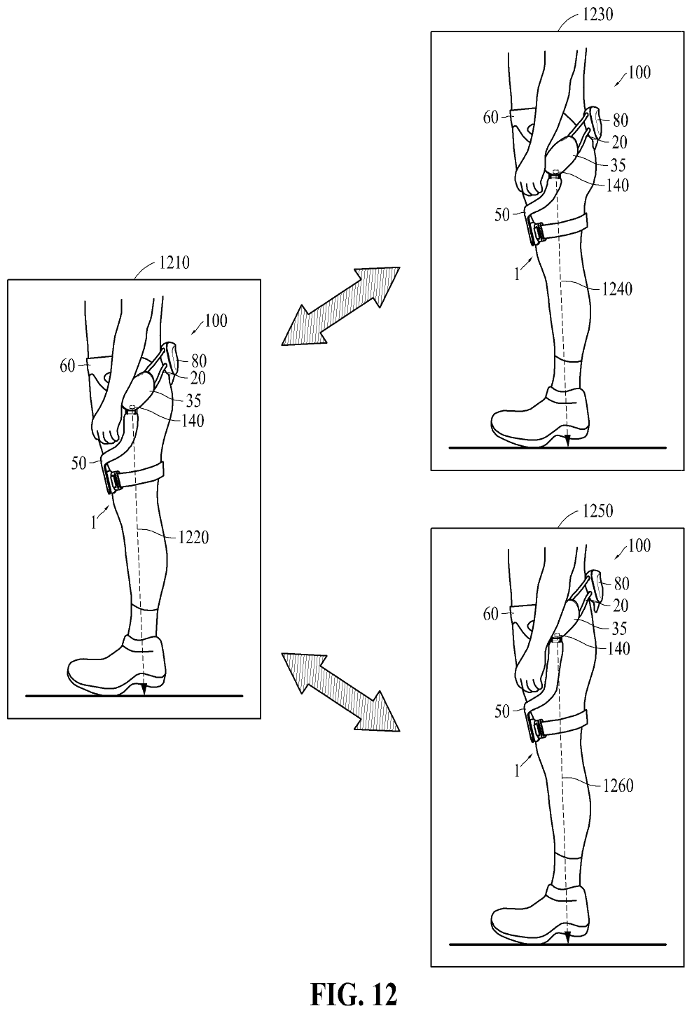

FIG. 12 is a diagram illustrating a wearable device performing a wearing state detection function using a distance sensor according to an embodiment.

Referring to FIG. 12, a situation 1210 for determining a reference distance range is illustrated. According to an embodiment, during a personalization process or a setting process of the wearable device 100 for a user, a reference distance range may be set. In the personalization process or the setting process, it may be assumed that the user wears the wearable device 100 in an appropriate wearing position (or a wearing height) and at least one processor (e.g., the processor 512 of FIGS. 5A and 5B) of the wearable device 100 may determine a measurement distance from the wearable device 100 to the ground through the first distance sensor 140. The at least processor may set the determined measurement distance to a reference distance 1220 corresponding to the appropriate wearing position. The reference distance range may be determined based on the set reference distance 1220. For example, the at least one processor may determine the reference distance range in which a value obtained by adding a constant to the reference distance 1220 is an upper bound value and a value obtained by subtracting the constant from the reference distance 1220 is a lower bound value. The at least one processor may store the reference distance 1220 and/or the reference distance range in a storage (e.g., the memory 514 of FIGS. 5A and 5B) of the wearable device 100.

After the reference distance range is determined, when the user does not use the wearable device 100, the user may remove the wearable device 100, and when the user desires to use the wearable device 100, the user may wear the wearable device 100 again. Each time the user wears the wearable device 100, the wearing position of the wearable device 100 may vary. For example, the wearable device 100 may be worn in a lower or higher position than the appropriate position.

In a situation 1230 in which the wearable device 100 is worn in a lower position than the appropriate position, the wearable device 100 may perform the wearing state detection function as follows. The at least one processor may determine a measurement distance 1240 from the wearable device 100 to the ground through the first distance sensor 140. The at least one processor may compare the measurement distance 1240 with the stored reference distance 1220 or may determine whether the measurement distance 1240 is included in the reference distance range. When the wearable device 100 is in the appropriate position, the measurement distance 1240 may be shorter than the measured reference distance 1220 or may not be included in the reference distance range. In this case, the at least one processor may recognize that the wearable device 100 is worn in a lower position than the appropriate position. When it is recognized that the wearable device 100 is worn in a lower position than the appropriate position, the at least one processor may control the sound output module to output the wearing guide content to guide the user to wear the wearable device 100 in the appropriate wearing position. The wearing guide content may be a guiding voice, saying, for example, “You are wearing the wearable device lower than usual. Please wear the waist belt slightly higher.”

In a situation 1250 in which the wearable device 100 is worn in a higher position than the appropriate position, the wearable device 100 may perform the wearing state detection function as follows. The at least one processor may determine a measurement distance 1260 from the wearable device 100 to the ground through the first distance sensor 140. The at least one processor may compare the measurement distance 1260 with the stored reference distance 1220 or may determine whether the measurement distance 1260 is included in the reference distance range. When the wearable device 100 is in the appropriate position, the measurement distance 1260 may be longer than the measured reference distance 1220 or may not be included in the reference distance range. In this case, the at least one processor may recognize that the wearable device 100 is worn in a higher position than the appropriate position. When it is recognized that the wearable device 100 is worn in a higher position than the appropriate position, the at least one processor may control the sound output module to output the wearing guide content to guide the user to wear the wearable device 100 in the appropriate wearing position. The wearing guide content may be a guiding voice, saying, for example, “You are wearing the wearable device higher than usual. Please lower the waist belt.”

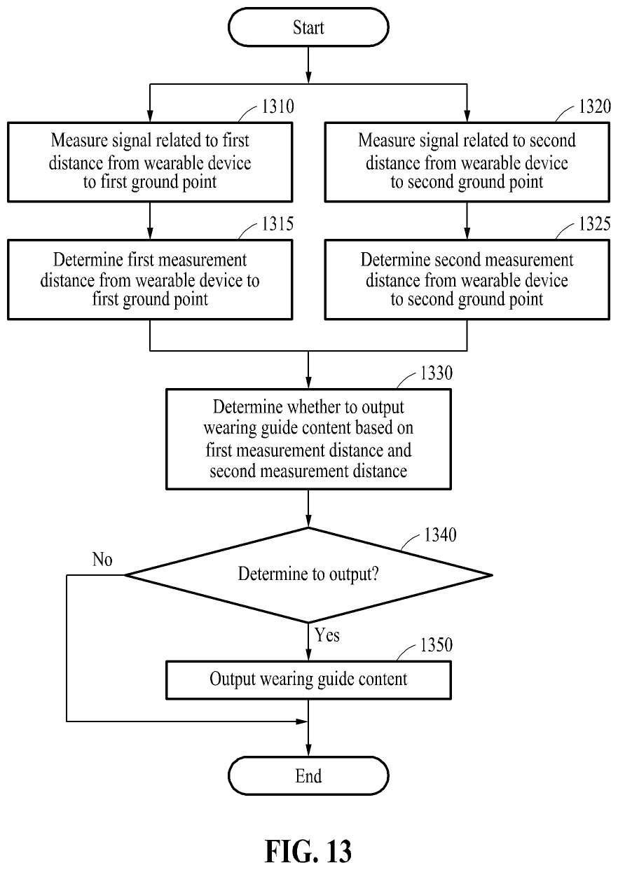

FIG. 13 is a flowchart illustrating operations of a control method of a wearable device performing a wearing state detection function according to an embodiment. In an embodiment, at least one of the operations of FIG. 13 may be simultaneously or parallelly performed with one another, and the order of the operations may be changed. In addition, at least one of the operations may be omitted, or another operation may be additionally performed.

Referring to FIG. 13, in operation 1310, the wearable device 100 may measure a signal related to a first distance from the wearable device 100 to a first ground point (e.g., the ground point G1 of FIG. 8A or the ground point G3 of FIG. 8B) using a first distance sensor (e.g., the first distance sensor 570 of FIG. 5B).

In operation 1320, the wearable device 100 may measure a signal related to a second distance from the wearable device 100 to a second ground point (e.g., the ground point G2 of FIG. 8A or the ground point G4 of FIG. 8B) that is different from the first ground point using a second distance sensor (e.g., the second distance sensor 575 of FIG. 5B). Operations 1310 and 1320 may be performed in parallel or may be sequentially performed, and there is no limitation on the order of execution.

In operation 1315, at least one processor (e.g., the processor 512 of FIGS. 5A and 5B) of the wearable device 100 may determine a first measurement distance from the wearable device 100 to the first ground point based on the signal measured by the first distance sensor. In operation 1325, the at least one processor may determine a second measurement distance from the wearable device 100 to the second ground point based on a signal measured by the second distance sensor.

In operation 1330, the at least one processor may determine whether to output the wearing guide content based on the first measurement distance determined in operation 1315 and the second measurement distance determined in operation 1325. The first measurement distance and the second measurement distance may correspond to wearing positions on both left and right sides of the user, respectively. For example, the first measurement distance may correspond to the wearing position of the wearable device 100 on the right side (or the left side) of the user and the second measurement distance may correspond to the wearing position of the wearable device 100 on the left side (or the right side) of the user. For example, when a difference between the first measurement distance and the second measurement distance is not included in a threshold range, the at least one processor may determine to output the wearing guide content. For example, when the difference between the first measurement distance and the second measurement distance is included in the threshold range, the at least one processor may determine not to output the wearing guide content. The fact that the difference between the first measurement distance and the second measurement distance is included in the threshold range may represent that the user wears the wearable device 100 close to the horizontal balance. The fact that the difference between the first measurement distance and the second measurement distance is not included in the threshold range may represent a great deviation between the left and right wearing heights of the wearable device 100 by the user.

Based on the determination in operation 1330, whether an output of the wearing guide content is determined may be determined in operation 1340. If it is determined to output the wearing guide content (“yes” in operation 1340), in operation 1350, the at least one processor may control a sound output module (e.g., the sound output module 550 of FIGS. 5A and 5B) of the wearable device 100 to output the wearing guide content corresponding to audio content. For example, a guiding voice saying, “The wearable device is tilted to the right. Please check the wearing state.” may be output through the wearable device 100 and the user may adjust the wearing state of the wearable device 100 through the guiding voice. Each time the user wears the wearable device 100 or performs exercise while wearing the wearable device 100, the wearable device 100 may determine the first measurement distance and the second measurement distance using the first distance sensor and the second distance sensor and may monitor the wearing state of the wearable device 100 based on the first measurement distance and the second measurement distance. The monitoring may be periodically or aperiodically performed.

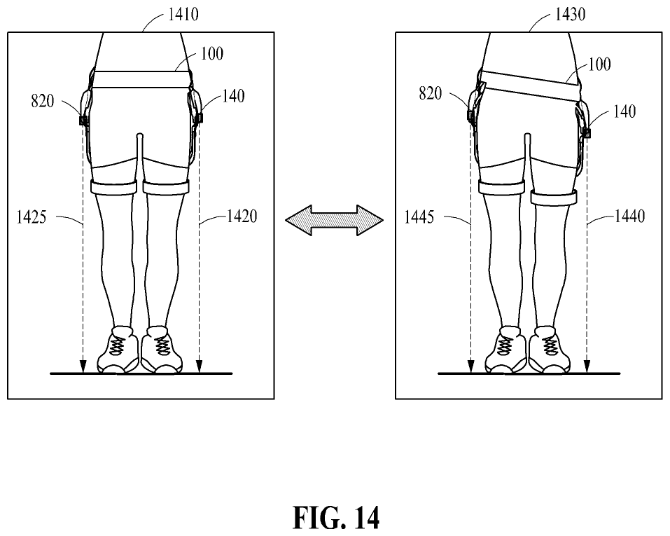

FIG. 14 is a diagram illustrating a wearable device performing a wearing state detection function using a plurality of distance sensors according to an embodiment.

Referring to FIG. 14, situations 1410 and 1430 in which the wearable device 100 is worn in different wearing states are illustrated. The situation 1410 may indicate a state in which the wearable device 100 is worn horizontally in balance and the situation 1430 may indicate a state in which the wearable device 100 is worn tilted to one side.

In the situation 1410, a first measurement distance 1420 from the wearable device 100 to the ground may be measured through the first distance sensor 140, and a second measurement distance 1425 from the wearable device 100 to the ground may be measured through the second distance sensor 820. At least one processor (e.g., the processor 512 of FIGS. 5A and 5B) of the wearable device 100 may calculate a difference between the first measurement distance 1420 and the second measurement distance 1425 by comparing the first measurement distance 1420 with the second measurement distance 1425. The at least one processor may estimate a horizontal wearing state of the wearable device 100 based on the difference between the first measurement distance 1420 and the second measurement distance 1425. When the wearable device 100 is worn horizontally in balance as shown in the situation 1410, the difference between the first measurement distance 1420 and the second measurement distance 1425 may be small enough to be included in a threshold range. When it is determined that the difference between the first measurement distance 1420 and the second measurement distance 1425 is included in the threshold range, the at least one processor may estimate that the wearable device 100 is worn horizontally in balance.

In the situation 1430, a first measurement distance 1440 from the wearable device 100 to the ground may be measured through the first distance sensor 140 and a second measurement distance 1445 from the wearable device 100 to the ground may be measured through the second distance sensor 820. The at least one processor may calculate a difference between the first measurement distance 1440 and the second measurement distance 1445 by comparing the first measurement distance 1440 with the second measurement distance 1445. When the wearable device 100 is worn tilted to the left side as shown in the situation 1430, the first measurement distance 1440 may be measured to be considerably shorter than the second measurement distance 1445 and the difference between the first measurement distance 1420 and the second measurement distance 1425 may be great enough not to be included in the threshold range. When it is determined that the difference between the first measurement distance 1420 and the second measurement distance 1425 is not included in the threshold range, the at least one processor may estimate that the wearable device 100 is not worn horizontally in balance (or the horizontal wearing position in unbalanced) and may control to output the wearing guide content to induce normal wearing of the wearable device 100 to the user. The wearing guide content may be a guiding voice saying, for example, “The wearable device is tilted to the right side. Please stand straight and fasten the belt to ensure the horizontal balance of the wearable device.”

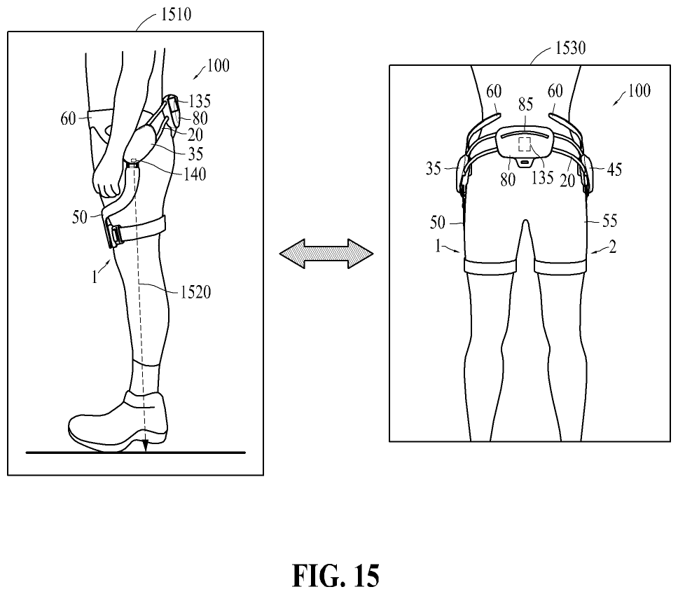

FIG. 15 is a diagram illustrating a wearable device performing a wearing state detection function using a distance sensor and an inertial sensor according to an embodiment.

Referring to FIG. 15, a left view 1510 of a user wearing the wearable device 100 and a rear view 1530 of the user are illustrated. The wearable device 100 may include the first distance sensor 140 configured to measure a first measurement distance 1520 from the wearable device 100 to the ground and the IMU 135 (e.g., the inertial sensor 522 of FIG. 5B) configured to measure a signal related to a tilting degree of the wearable device 100. As described with reference to FIG. 13, at least one processor (e.g., the processor 512 of FIGS. 5A and 5B) of the wearable device 100 may determine a first measurement distance 1520 from the wearable device 100 to a first ground point based on a signal measured by the first distance sensor 140 and may determine whether the wearable device 100 is worn at the appropriate height based on whether the determined first measurement distance 1520 is included in a preset reference distance range. The at least one processor may determine a tilting degree (e.g., a degree of tilting in the horizontal direction) of the wearable device 100 based on a signal measured by the IMU 135 and may determine whether the wearable device 100 is worn horizontally in balance based on the determined tilting degree. When the tilting degree of the wearable device 100 measured by the IMU 135 is included in a threshold range, the at least one processor may determine not to output the wearing guide content. When the tilting degree of the wearable device 100 is not included in the threshold range, the at least one processor may control a sound output module (e.g., the sound output module 550 of FIGS. 5A and 5B) of the wearable device 100 to output the wearing guide content to induce normal wearing of the wearable device 100 to the user.

Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

It should be appreciated that various embodiments of the present disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B,” “at least one of A and B,” “at least one of A or B,” “A, B or C,” “at least one of A, B and C,” and “at least one of A, B, or C,” may include any one of the items listed together in the corresponding one of the phrases, or all possible combinations thereof. Terms such as “1st” and “2nd,” or “first” and “second” may be used to simply distinguish a corresponding component from other components, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., by wire), wirelessly, or via at least a third element(s).

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Accordingly, each “module” in the present disclosure may include a circuit.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums. Embodiments as set forth herein may be implemented as software including one or more instructions that are stored in a storage medium that is readable by a machine. For example, a processor of the machine may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device and does not include a signal (e.g., an electromagnetic wave), but this term does not differentiate between where data is semi-permanently stored in the storage medium and where the data is temporarily stored in the storage medium.

According to an embodiment, a method according to embodiments may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or multiple entities, and some of the multiple entities may be separately disposed in different components. According to embodiments, one or more of the above-described components may be omitted, or one or more other components may be added. Alternatively or additionally, a plurality of components (e.g., modules or programs) may be integrated into a single component. In such a case, according to embodiments, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

Although the present disclosure exemplifies and describes with reference to various embodiments, it shall be construed that various embodiments are for the illustrative purpose rather than limiting. It shall be further understood by those skilled in the art that various changes in forms and details may be made without departing from the true spirit and full scope of this disclosure including the scope of the attached claims and their equivalents. In addition, it shall be construed that the embodiments described herein may be used with other embodiments of the present disclosure. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A wearable device comprising:
at least one driving module, comprising a motor, configured to generate torque;
a torque transmission frame configured to transmit the generated torque to a leg of a user to be wearing the wearable device;
a fastener connected to the torque transmission frame and configured to fasten the wearable device to the leg of the user;
a first distance sensor configured to measure a signal related to a first distance from the wearable device to a first ground point;
a second distance sensor configured to measure a signal related to a second distance from the wearable device to a second ground point that is different from the first ground point; and
at least one processor, comprising processing circuitry, individually and/or collectively configured to control an operation of the wearable device, including to:
determine a first measurement distance from the wearable device to the first ground point based on a signal measured by the first distance sensor,
determine a second measurement distance from the wearable device to the second ground point based on a signal measured by the second distance sensor,
estimate a terrain type of a ground on which the user is located, based on the determined first measurement distance and the determined second measurement distance, and
control the at least one driving module based on the estimated terrain type.

2. The wearable device of claim 1, wherein the at least one processor is individually and/or collectively configured to:
estimate the terrain type of the ground on which the user is located, based on a first reference distance determined based on a signal measured by the first distance sensor when the user is on a reference terrain, a second reference distance determined based on a signal measured by the second distance sensor when the user is on reference terrain, the first measurement distance, and the second measurement distance.

3. The wearable device of claim 2, wherein the at least one processor is individually and/or collectively configured to:
estimate the terrain type of the ground on which the user is located based on a comparison result between a reference ground length, which is to be determined based on the first reference distance and the second reference distance, and a measurement ground length, which is to be determined based on the first measurement distance and the second measurement distance.

4. The wearable device of claim 1, wherein the at least one processor is individually and/or collectively configured to:
estimate the terrain type of the ground on which the user is located as one of a flat ground, an uphill terrain, and a downhill terrain based on the determined first measurement distance and the determined second measurement distance.

5. The wearable device of claim 1, wherein the at least one processor is individually and/or collectively configured to:
control to change a magnitude of torque generated by the at least one driving module and an operation mode of the at least one driving module, based on the estimated terrain type.

6. The wearable device of claim 5, wherein the at least one processor is individually and/or collectively configured to:
when the operation mode of the at least one driving module is in an assistance mode for generating an assistance force to assist a leg motion of the user and the terrain type of the ground on which the user is located is estimated as an uphill terrain, control to increase a magnitude of the assistance force generated by the at least one driving module.

7. The wearable device of claim 5, wherein the at least one processor is individually and/or collectively configured to:
when the operation mode of the at least one driving module is in an assistance mode for generating an assistance force to assist a leg motion of the user and the terrain type of the ground on which the user is located is estimated as a downhill terrain, control the operation mode of the at least one driving module to change to a resistance mode for generating a resistance force to hinder the leg motion of the user and/or control to stop generating the assistance force.

8. The wearable device of claim 5, wherein the at least one processor is individually and/or collectively configured to:
when the operation mode of the at least one driving module is in a resistance mode for generating a resistance force to hinder a leg motion of the user and the terrain type of the ground on which the user is located is estimated as a downhill terrain, control to increase a magnitude of the resistance force generated by the at least one driving module.

9. The wearable device of claim 5, wherein the at least one processor is individually and/or collectively configured to:
when the operation mode of the at least one driving module is in a resistance mode for generating a resistance force to hinder a leg motion of the user and the terrain type of the ground on which the user is located is estimated as an uphill terrain, control the operation mode of the at least one driving module to change to an assistance mode for generating an assistance force to assist the leg motion of the user and/or control to stop generating the resistance force.

10. The wearable device of claim 5, wherein, while the operation mode of the at least one driving module is in a non-torque mode in which the torque is not generated, the at least one processor is individually and/or collectively configured to:
when the terrain type of the ground on which the user is located is estimated as an uphill terrain, control the operation mode of the at least one driving module to change to an assistance mode for generating an assistance force to assist a leg motion of the user, and
when the terrain type of the ground on which the user is located is estimated as a downhill terrain, control the operation mode of the at least one driving module to change to a resistance mode for generating a resistance force to hinder a leg motion of the user.

11. The wearable device of claim 1, wherein the first distance sensor is configured to:
measure a signal related to the first measurement distance to the first ground point positioned in a forward direction than the second ground point.

12. A wearable device comprising:
at least one driving module, comprising a motor, configured to generate torque;
a torque transmission frame configured to transmit the generated torque to a leg of a user to be wearing the wearable device;
a fastener connected to the torque transmission frame and configured to fasten the wearable device to the leg of the user;
a first distance sensor configured to measure a signal related to a distance from the wearable device to a first ground point; and
at least one processor, comprising processing circuitry, individually and/or collectively configured to control an operation of the wearable device, to:
determine a first measurement distance from the wearable device to the first ground point based on a signal measured by the first distance sensor, and
determine whether to output wearing guide content to induce normal wearing of the wearable device based on the determined first measurement distance.

13. The wearable device of claim 12, wherein the at least one processor is individually and/or collectively configured to:
when the first measurement distance is not included in a preset reference distance range, determine to output the wearing guide content.

14. The wearable device of claim 12, further comprising:
a second distance sensor configured to measure a signal related to a second measurement distance from the wearable device to a second ground point that is different from the first ground point, and
wherein the at least one processor is individually and/or collectively configured to:
determine a second measurement distance from the wearable device to the second ground point based on a signal measured by the second distance sensor, and
determine whether to output the wearing guide content based on the first measurement distance and the second measurement distance.

15. The wearable device of claim 14, wherein the at least one processor is individually and/or collectively configured to:
when a difference between the first measurement distance and the second measurement distance is not included in a threshold range, determine to output the wearing guide content.

16. The wearable device of claim 12, further comprising:
an inertia measurement unit (IMU) sensor configured to measure a signal related to a tilting degree of the wearable device, and
wherein the at least one processor is individually and/or collectively configured to:
determine the tilting degree of the wearable device based on a signal measured by the IMU sensor, and
determine whether to output the wearing guide content to induce normal wearing of the wearable device based on the determined tilting degree.

17. A control method of the wearable device comprising at least one driving module, a first distance sensor, and a second distance sensor, the control method comprising:
measuring a signal related to a first distance from the wearable device to a first ground point using the first distance sensor;
measuring a second distance from the wearable device to a second ground point that is different from the first ground point using the second distance sensor;
determining a first measurement distance from the wearable device to the first ground point based on a signal measured by the first distance sensor;
determining a second measurement distance from the wearable device to the second ground point based on a signal measured by the second distance sensor;
estimating a terrain type of a ground on which a user is located, based on the determined first measurement distance and the determined second measurement distance; and
controlling the at least one driving module, comprising a motor and/or circuitry, based on the estimated terrain type.

18. A control method of a wearable device comprising at least one driving module and a first distance sensor, the control method comprising:
measuring a signal related to a first distance from the wearable device to a first ground point using the first distance sensor;
determining a first measurement distance from the wearable device to the first ground point based on a signal measured by the first distance sensor; and
determining whether to output wearing guide content to induce normal wearing of the wearable device based on the determined first measurement distance.

19. The control method of claim 18, wherein the wearable device further comprises a second distance sensor, and the method comprises using the second distance sensor to measure a signal related to a second measurement distance from the wearable device to a second ground point that is different from the first ground point, and
determining a second measurement distance from the wearable device to the second ground point based on a signal measured by the second distance sensor, and
the determining of whether to output the wearing guide content comprises determining whether to output the wearing guide content based on the first measurement distance and the second measurement distance.

20. At least one non-transitory computer-readable storage medium, individually and/or collectively storing instructions that, when executed by at least one processor, cause the at least one processor to perform the method of claim 17.
